(19) United States
(12) Patent Application Publication
(10) Pub. No.: US 2017/0347126 A1
(43) Pub. Date: Nov. 30, 2017

(54) VIDEO DEBANDING USING ADAPTIVE FILTER SIZES AND GRADIENT BASED BANDING DETECTION

(71) Applicant: QUALCOMM Incorporated, San Diego, CA (US)

(72) Inventor: Alireza SHOA HASSANI LASHDAN, Burlington, CA (US)

(21) Appl. No.: 15/339,377

(22) Filed: Oct. 31, 2016

Related U.S. Application Data
(60) Provisional application No. 62/342,783, filed on May 27, 2016.

(51) Int. Cl. H04N 19/86; H04N 19/117; H04N 19/147; H04N 19/82

(52) U.S. Cl. CPC H04N 19/86; H04N 19/82; H04N 19/117; H04N 19/147

(57) ABSTRACT

The present disclosure provides various aspects related to removing or reducing banding artifacts by performing video debanding using adaptive filter sizes and gradient based banding detection. For example, a method is described for processing banding artifacts in video data in which banding artifact detection is performed on a target pixel location in the video data. The banding artifact detection may involve identifying whether gradients within the filter kernel have the same sign. In response to the detection of a banding artifact, a filter size may be adapted based on content in the video data, where the filter size is adapted from a set of filter sizes. Then, a debanding filter having the adapted filter size may be applied to a value of the target pixel location to at least reduce the banding artifact. The video debanding may be performed horizontally and vertically to the video data using one-dimensional separable filters.

### PRIORITY

The present application for patent claims priority to Provisional Application No. 62/342,783 entitled “VIDEO DEBANDING USING ADAPTIVE FILTER SIZES AND GRADIENT BASED BANDING DETECTION” filed on May 27, 2016, which is assigned to the assignee hereof and hereby expressly incorporated by reference herein for all purposes.

### BACKGROUND

This present disclosure is related to various techniques used in video processing applications. More specifically, this disclosure relates to techniques for video debanding to remove or reduce banding artifacts.

In video processing, there may be instances in which contouring visual artifacts are observed in regions of a video image with very low texture. The contours formed in low texture regions by pixels with the same or similar level may be referred to as contouring artifacts, and more typically banding artifacts. In some instances, these banding artifacts may result from the quantization of regions or areas of a video image that have low gradients or ramps (e.g., gradients or ramps with small slopes). These regions or areas may be referred to as flat areas of a video image. For example, the quantization of low gradient areas to 8 bits may result in banding artifacts.

There may be different reasons for the presence of banding artifacts in an encoded video image. Typical sources of banding artifacts include the use of limited bit depth, the use of post processing filters, and effects from video image compression.

For example, banding artifacts may be more noticeable when fewer bits per pixel are used to represent the colors and/or the intensity level of pixels. As such, when pixel values are represented using 12 bits there may be fewer banding artifacts than when pixel values are represented using 8 bits.

The use of post processing filters may also produce banding artifacts because textured areas are filtered into flat areas and the quantization of the flat areas may result in banding artifacts. That is, the truncation that occurs from quantization of the filtered areas may be visible as banding or contouring artifacts.

Moreover, the use of video compression may also result in banding artifacts. Video compression is typically performed using blocks of pixel values and the blocks tend to be noticeable in the video image. To address this issue, video coding standards such as H.264, for example, apply deblocking filters to remove or reduce the effect of blocking artifacts; however, the use of deblocking filters may introduce banding artifacts.

Although different solutions have been proposed to remove or reduce the effects of banding artifacts, it is desirable to enable more efficient and effective techniques for video debanding than those currently available.

### SUMMARY

Aspects of the present disclosure provide various techniques used in video processing applications. More specifically, this disclosure relates to techniques for video debanding to remove or reduce banding artifacts by using adaptive filter sizes and gradient based banding detection.

In one aspect, a method is described for processing banding artifacts in video data in which banding artifact detection is performed on a target pixel location in the video data. The banding artifact detection may involve identifying whether gradients within the filter kernel have the same sign. In response to the detection of a banding artifact, a filter size may be adapted based on content in the video data, where the filter size is adapted from a set of filter sizes. Then, a debanding filter having the adapted filter size may be applied to a value of the target pixel location to at least reduce the banding artifact. The video debanding may be performed horizontally and vertically to the video data using one-dimensional separable filters.

In another aspect, a device is described for processing banding artifacts in video data, where the device includes a memory configured to store video data and a processor. The processor may be configured to perform banding artifact detection on a target pixel location in the video data. The banding artifact detection may involve identifying whether gradients within the filter kernel have the same sign. The processor may be further configured to adapt, in response to the detection of a banding artifact, a filter size based on content in the video data, the filter size being adapted from a set of filter sizes. The processor may also be configured to apply, to a value of the target pixel location, a debanding filter having the adapted filter size to at least reduce the banding artifact. The video debanding may be performed by the device horizontally and vertically to the video data using one-dimensional separable filters.

In yet another aspect, a non-transitory computer-readable medium storing code is described for processing banding artifacts in video data. The code may be executable by a processor to perform a method that includes performing banding artifact detection on a target pixel location in the video data. The banding artifact detection may involve identifying whether gradients within the filter kernel have the same sign. The method may further include adapting, in response to the detection of a banding artifact, a filter size based on content in the video data, the filter size being adapted from a set of filter sizes. The method may also include applying, to a value of the target pixel location, a debanding filter having the adapted filter size to at least reduce the banding artifact. The video debanding may be performed horizontally and vertically to the video data using one-dimensional separable filters.

In another aspect, a method is described for processing banding artifacts in video data in which a first banding artifact correction is performed in a first direction on a target pixel location in the video data based on a first debanding filter. The first banding artifact correction may include performing banding artifact detection on the target pixel. The first banding artifact correction may further include adapting in response to the detection of a banding artifact a filter size of the first debanding filter based on content in the video data, where the filter size is adapted from a set of filter sizes. The first banding artifact correction may also include applying, to a value of the target pixel location, the first debanding filter having the adapted filter size to produce a filtered value of the target pixel location. A second banding artifact correction may also be performed in a second direction on the target pixel location based on a second debanding filter. The second banding artifact correction may include performing banding artifact detection on the target pixel. The second banding artifact correction may further include adapting, in response to the detection of a banding artifact, a filter size of the second debanding filter based on content in the video data, where the filter size is adapted from the set of filter sizes. The second banding artifact correction may also include applying, to the filtered value of the target pixel location, the second debanding filter having the adapted filter size. In this method, the first direction may be a horizontal direction of the video data and the second direction may be a vertical direction of the video data, or the first direction may be the vertical direction of the video data and the second direction may be the horizontal direction of the video data.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1A is a block diagram illustrating an example of an encoding device and a decoding device, in accordance with various aspects of the disclosure.

FIG. 1B is a diagram illustrating an example of a network including a wireless communication device, in accordance with various aspects of the disclosure.

FIG. 2 is a block diagram illustrating an example of a video encoding device, in accordance with various aspects of the disclosure.

FIG. 3 is a block diagram illustrating an example of a video decoding device, in accordance with various aspects of the disclosure.

FIGS. 4A and 4B are images illustrating an example of an original image having banding artifacts and the same image after video debanding, respectively.

FIGS. 5A and 5B are images illustrating an example of an original image having banding artifacts and the same image after video debanding, respectively.

FIG. 6 is a diagram illustrating a current video debanding approach to correct for the presence of banding artifacts.

FIG. 7A is a block diagram illustrating an example of a proposed video debanding approach to correct for the presence of banding artifacts, in accordance with various aspects of the disclosure.

FIG. 7B is a block diagram illustrating another example of a proposed video debanding approach to correct for the presence of banding artifacts, in accordance with various aspects of the disclosure.

FIGS. 8A and 8B are diagrams illustrating examples where banding detection passes for a particular debanding filter size, in accordance with various aspects of the disclosure.

FIG. 9A is a diagram illustrating an example where banding detection does not pass because of edges with different signs in a filter kernel, in accordance with various aspects of the disclosure.

FIG. 9B is a diagram illustrating an example where a smaller debanding filter size is used to enable banding detection to pass in cases of edges with different signs in a filter kernel, in accordance with various aspects of the disclosure.

FIG. 10 is a diagram illustrating an example where banding detection does not pass because of a large gradient or edge, in accordance with various aspects of the disclosure.

FIG. 11 is a flow diagram illustrating an example of a video debanding algorithm that uses filter size adaptation to correct for the presence of banding artifacts, in accordance with various aspects of the disclosure.

FIG. 12 is a diagram illustrating an example of filter size adaptation in both horizontal and vertical debanding filtering, in accordance with various aspects of the disclosure.

FIG. 13 is a block diagram illustrating an example of a processing system configured to perform various video debanding aspects, in accordance with various aspects of the disclosure.

FIG. 14 is a flow chart illustrating an example of a method for video debanding, in accordance with various aspects of the disclosure.

FIG. 15 is a flow chart illustrating an example of another method for video debanding, in accordance with various aspects of the disclosure.

### DETAILED DESCRIPTION

Certain aspects and embodiments of this disclosure are provided below. For example, various aspects related to video debanding using adaptive filter sizes and gradient based banding detection are described. Video debanding, as described herein, is used to produce fewer noticeable banding artifacts to a viewer, and may include the use of banding artifact detection, also referred to as banding detection, as well as debanding filtering. Some of these aspects may be applied independently and some of them may be applied in combination as would be apparent to those of skill in the art. In the following description, for the purposes of explanation, specific details are set forth in order to provide a thorough understanding of the disclosure. It is to be understood by one of ordinary skill in the art that the various aspects of the proposed video debanding techniques described in this disclosure may be practiced without these specific details. For example, circuits, systems, networks, processes, and other components may be shown as components in block diagram form in order not to obscure the various aspects in unnecessary detail. In other instances, well-known circuits, processes, algorithms, structures, and techniques may be shown without unnecessary detail in order to avoid obscuring the various aspects being described.

The proposed video debanding techniques described in this disclosure may be implemented in different types of devices, including wireless communication devices that are used to send and/or receive information representative of video data. The wireless communication devices may be, for example, a cellular telephone or similar device, and the information representative of the video data may be transmitted and/or received by the wireless communication device and may be modulated according to a cellular communication standard.

As described above, some of the sources of banding artifacts include the use of limited bit depth, the use of post processing filters, and effects from video image compression. To remove or reduce the visual effects caused by banding artifacts, various solutions have been proposed that typically involve the use of banding detection operations, the application of a smoothing filter, and the subsequent application of dither and/or noise injection. Banding artifact detection, or banding detection, is first used to determine or identify whether a particular area or region of a video image has banding artifacts. A smoothing filter is then used in areas with banding artifacts to try to reconstruct the original information before it was truncated by quantization. Application of a smoothing filter may be referred to as debanding filtering and the filter may be referred to as a debanding filter. This filtering step tends to add precision (e.g., higher bit depth) in order to remove the contours or bands in the video image. For example, the filtering step produces pixels with 12 bit values when 8 bit values are needed for further processing or manipulation of the video image. Dithering is subsequently used to convert the pixel values back to the desired bit depth (e.g., 8 bits) and noise may also injected.

These solutions, however, may present some issues that limit their effectiveness. For example, there may be regular instances of misdetection, there may be loss of detail resulting from the use of large, fixed filter sizes, or there may be artifacts caused by the abrupt transition between regions where filtering is applied (e.g., regions were banding artifacts are detected) and regions where filtering is not applied (e.g., regions were banding artifacts are not detected).

The misdetection or misidentification of banding artifacts that occurs in current solutions may cause loss of detail and texture in the video image. Also, there may instances in which large flat areas of a video image are isolated and filtered, while smaller areas of that same video image are overlooked and banding artifacts may therefore remain in those overlooked areas.

The use of large, fixed filter sizes in current solutions may also present some issues because the bands depend on the size of the flat areas, which depend on the video content in those areas. To achieve better results it may be necessary to match the size of the debanding filter to the size of the flat area. Having large, fixed filter sizes does not provide the needed flexibility and a variable or adaptable filter size may be useful instead because there may be different sizes of flat areas in a video image. Another issue with the filtering process of current solutions is that the filters used are typically noise reduction filters, which are expensive and not particularly designed for handling banding artifacts. Therefore, it is desirable to improve upon current solutions by having a debanding filter that is configured for these types of applications and that adapts to the size of the content and/or to the contents in the video image.

In addition, because current solutions use techniques that are based on simply detecting areas with banding artifacts and areas without banding artifacts, abrupt changes between these areas tend to also produce artifacts in the video image. Moreover, these abrupt changes may be affected by the misdetection or misidentification of banding artifacts described above.

Accordingly, the present disclosure provides video debanding techniques that address the issues described above by using adaptive filter sizes and gradient based banding detection. The proposed video debanding techniques use multiple filter sizes together with banding detection, where the size of the debanding filter may be adapted based on the size of the area with the banding artifact, and where the banding detection may be based on gradients within the filter kernel. The proposed video debanding techniques involve the use of banding detection in which pixels that may have a banding artifact or that are part of a banding artifact are identified, the use of a debanding filter (e.g., a one-dimensional (1D) finite impulse response (FIR) filter) that is applied to the identified pixels, and dithering to convert the pixel values to the appropriate bit depth (e.g., 8 bits). The proposed video debanding techniques, which are described in more detail below, provide a smooth transition between different filter sizes, low computational complexity, and strong filtering without any loss of detail. The proposed video debanding techniques may be applied first in one direction (e.g., vertically/horizontally) on a video image, and may be then applied in a different direction (e.g., horizontally/vertically) on the video image to separately address banding artifacts in each of those directions. Moreover, the proposed video banding techniques may be applied in a per pixel basis (e.g., processing each pixel separately). Accordingly, references to a pixel in a video image may refer to the pixel location or to a value of the pixel, as appropriate. For example, filtering may be performed on a value of a pixel at a particular pixel location.

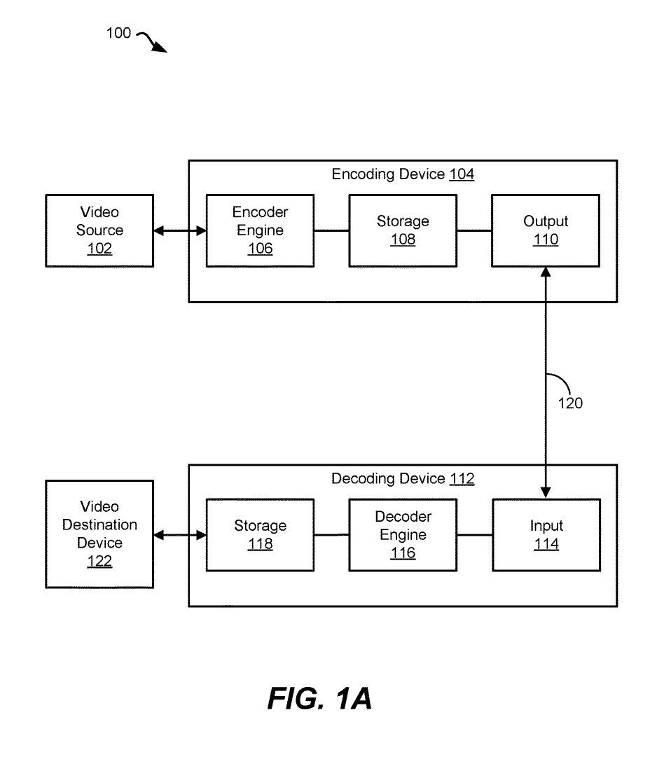

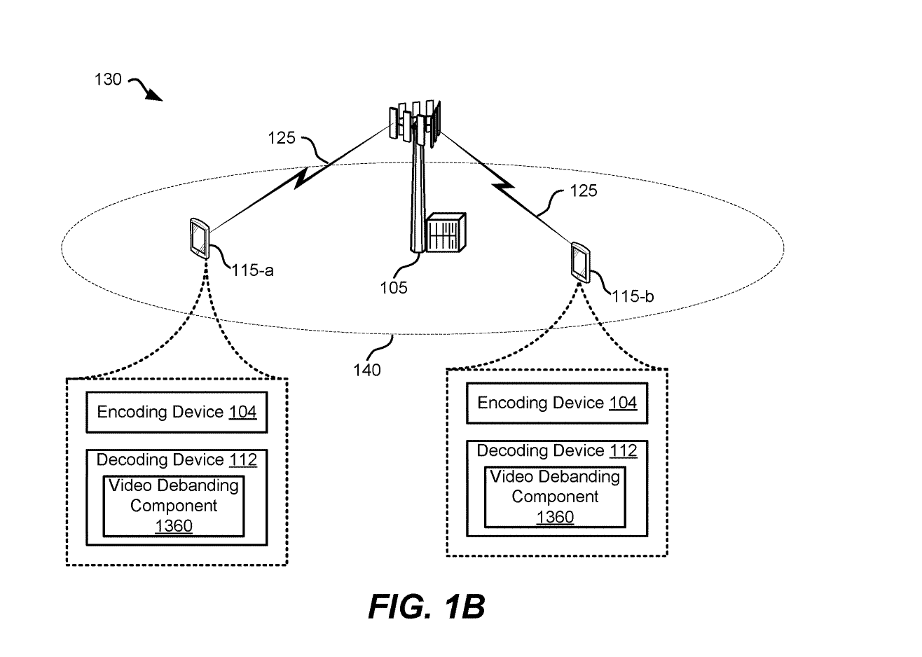

FIG. 1A is a block diagram illustrating an example of a system 100. Aspects of the system 100 may be used in connection with the various techniques described herein for video debanding using adaptive filter sizes and gradient based banding detection. As described above, banding artifacts may occur when quantizing areas in a video image that have relatively slow changing gradients or ramps. For example, when the value of a first group of consecutive pixels (e.g., 8 or more pixels) in a row or column of the video image does not change, and the value of an adjacent group of consecutive pixels (e.g., 8 or more) in the same row or column is higher by one bit, the area or region of the row or column having the two groups of pixels may be said to have a slow changing gradient/ramp or a low gradient/ramp. The point at which the row or column transitions to the higher pixel value may be referred to as an edge, which may correspond or represent the gradient or ramp where the edge occurs. In these areas, video debanding may be used to remove or reduce the visual effects of the banding artifacts. In areas of a video image that show texture, any slow changing gradients or ramps may be masked by high spatial frequency components of the video image. In such areas, therefore, banding artifacts are less likely to occur or be noticeable and video debanding may not be necessary or effective.

The system 100 may include an encoding device 104 and a decoding device 112. The encoding device 104 may be part of a source device, and the decoding device 112 may be part of a receiving or destination device. It is to be understood, however, that a source device may include both an encoding device 104 and a decoding device 112; similarly for a receiving device (see e.g., FIG. 1B). The source device and/or the receiving device may include or may be part of an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, or any other suitable electronic device. In some examples, the source device and the receiving device may include one or more wireless transceivers for wireless communications. The various coding techniques described herein are applicable to video coding in various multimedia applications, including streaming video transmissions (e.g., over the internet), television broadcasts or transmissions, encoding of digital video for storage on a data storage medium, decoding of digital video stored on a data storage medium, or other applications. In some examples, system 100 can support one-way or two-way video transmission to support applications such as video conferencing, video streaming, video playback, video broadcasting, gaming, virtual reality, and/or video telephony. Moreover, a source device as described above may include a video source, a video encoder, and a output interface. A destination device as described above may include an input interface, a video decoder, and a display device. A display device as described herein may display video data to a user, and may comprise any of a variety of display devices such as a cathode ray tube (CRT), a liquid crystal display (LCD), a plasma display, an organic light emitting diode (OLED) display, or another type of display device.

The encoded video data received by the decoding device 112 may contain banding artifacts that may be noticeable to the content viewer if not corrected. While the size and quality of the display as well as the distance to the display and that amount of ambient light in the viewing environment may play a role in how visible these banding artifacts are to a viewer, current display technologies are such that most viewers are likely to notice the presence of banding artifacts. Aspects of video debanding as described in more detail below may be generally implemented in the decoding device 112 to correct for the presence of banding artifacts. In one example, video debanding may take place after decoding of the encoded video data (e.g., encoded video images) by the decoding device 112. In another example, video debanding may be implemented as part of or in connection with the decoding of the encoded video data.

The encoding device 104 can be used to encode video data using a video coding standard or protocol to generate an encoded video bitstream. Video coding standards include ITU-T H.261, ISO/IEC MPEG-1 Visual, ITU-T H.262 or ISO/IEC MPEG-2 Visual, ITU-T H.263, ISO/IEC MPEG-4 Visual and ITU-T H.264 (also known as ISO/IEC MPEG-4 AVC), including its Scalable Video Coding (SVC) and Multiview Video Coding (MVC) extensions. Another coding standard, High-Efficiency Video Coding (HEVC), has been finalized by the Joint Collaboration Team on Video Coding (JCT-VC) of ITU-T Video Coding Experts Group (VCEG) and ISO/IEC Motion Picture Experts Group (MPEG). Various extensions to HEVC deal with multi-layer video coding and are also being developed by the JCT-VC, including the multiview extension to HEVC, called MV-HEVC, and the scalable extension to HEVC, called SHVC, or any other suitable coding protocol. Further, investigation of new coding tools for screen-content material such as text and graphics with motion has been conducted, and technologies that improve the coding efficiency for screen content have been proposed. A H.265/HEVC screen content coding (SCC) extension is being developed to cover these new coding tools.

Various aspects of the disclosure describe examples for which the HEVC standard, or extensions thereof (e.g., Multiview Video Coding extension, referred to as MV-HEVC, and the Scalable Video Coding extension, referred to as SHVC), may be used in connection with aspects of video debanding. For example, banding artifacts may in some instances result from operations performed in connection with the HEVC standard, or extensions thereof. However, the techniques and systems described herein may also be applicable when using other coding standards, such as AVC, MPEG, extensions thereof, or other suitable coding standards. Accordingly, while the techniques and systems described herein may be described with reference to the use of a particular video coding standard, one of ordinary skill in the art will appreciate that the description should not be so limited and need not be interpreted to apply only to that particular standard. For example, the video debanding techniques described herein may be used to correct banding artifacts resulting from operations performed using different coding standards.

A video source 102 may provide the video data to the encoding device 104. The video source 102 may be part of the source device, or may be part of a device other than the source device. The video source 102 may include a video capture device (e.g., a video camera, a camera phone, a video phone, or the like), a video archive containing stored video, a video server or content provider providing video data, a video feed interface receiving video from a video server or content provider, a computer graphics system for generating computer graphics video data, a combination of such sources, or any other suitable video source.

The video data from the video source 102 may include one or more input pictures or frames. A picture or frame is a still image that is part of a sequence of images that form a video. A picture or frame, or a portion thereof, may be referred to as a video image. The encoder engine 106 (or encoder) of the encoding device 104 encodes the video data to generate an encoded video bitstream (e.g., a sequence of encoded video images). In some examples, an encoded video bitstream (or “bitstream”) is a series of one or more coded video sequences. A coded video sequence (CVS) includes a series of access units (AUs) starting with an AU that has a random access point picture in the base layer and with certain properties up to and not including a next AU that has a random access point picture in the base layer and with certain properties. An HEVC bitstream, for example, may include one or more CVSs including data units called network abstraction layer (NAL) units.

The encoder engine 106 generates coded representations of pictures by partitioning each picture into multiple slices. A slice is independent of other slices so that information in the slice is coded without dependency on data from other slices within the same picture. A slice includes one or more slice segments including an independent slice segment and, if present, one or more dependent slice segments that depend on previous slice segments. The slices are then partitioned into coding tree blocks (CTBs) of luma samples and chroma samples. Luma generally refers to the level of brightness of a sample and is considered achromatic. Chroma, on the other hand, refers to a color level and carries color information. Luma and chroma values for a particular pixel location (e.g., pixel values) may be provided using a certain bit depth. A CTB of luma samples and one or more CTBs of chroma samples, along with syntax for the samples, are referred to as a coding tree unit (CTU). A CTU is the basic processing unit for HEVC encoding. A CTU can be split into multiple coding units (CUs) of varying sizes. A CU contains luma and chroma sample arrays that are referred to as coding blocks (CBs). The luma and chroma CBs can be further split into prediction blocks (PBs). A PB is a block of samples of the luma or a chroma component that uses the same motion parameters for inter-prediction. The luma PB and one or more chroma PBs, together with associated syntax, form a prediction unit (PU). Once the pictures of the video data are partitioned into CUs, the encoder engine 106 predicts each PU using a prediction mode. The prediction is then subtracted from the original video data to get residuals (described below). For each CU, a prediction mode may be signaled inside the bitstream using syntax data. A prediction mode may include intra-prediction (or intra-picture prediction) or inter-prediction (or inter-picture prediction). Using intra-prediction, each PU is predicted from neighboring image data in the same picture using, for example, DC prediction to find an average value for the PU, planar prediction to fit a planar surface to the PU, direction prediction to extrapolate from neighboring data, or any other suitable types of prediction. Using inter-prediction, each PU is predicted using motion compensation prediction from image data in one or more reference pictures (before or after the current picture in output order). The decision whether to code a picture area using inter-picture or intra-picture prediction may be made, for example, at the CU level.

In some examples, inter-prediction using uni-prediction may be performed, in which case each prediction block can use one motion compensated prediction signal, and P prediction units are generated. In some examples, inter-prediction using bi-prediction may be performed, in which case each prediction block uses two motion compensated prediction signals, and B prediction units are generated.

A PU may include data related to the prediction process. For example, when the PU is encoded using intra-prediction, the PU may include data describing an intra-prediction mode for the PU. As another example, when the PU is encoded using inter-prediction, the PU may include data defining a motion vector for the PU. The encoder engine 106 in the encoding device 104 may then perform transformation and quantization. For example, following prediction, the encoder engine 106 may calculate residual values corresponding to the PU. Residual values may comprise pixel difference values. Any residual data that may be remaining after prediction is performed is transformed using a block transform, which may be based on discrete cosine transform, discrete sine transform, an integer transform, a wavelet transform, or other suitable transform function. In some cases, one or more block transforms (e.g., sizes 32×32, 16×16, 8×8, 4×4, or the like) may be applied to residual data in each CU. In some embodiments, a transform unit (TU) may be used for the transform and quantization processes implemented by the encoder engine 106. A given CU having one or more PUs may also include one or more TUs. As described in further detail below, the residual values may be transformed into transform coefficients using the block transforms, and then may be quantized and scanned using TUs to produce serialized transform coefficients for entropy coding.

In some embodiments following intra-predictive or inter-predictive coding using PUs of a CU, the encoder engine 106 may calculate residual data for the TUs of the CU. The PUs may comprise pixel data in the spatial domain (or pixel domain). The TUs may comprise coefficients in the transform domain following application of a block transform. As previously noted, the residual data may correspond to pixel difference values between pixels of the unencoded picture and prediction values corresponding to the PUs. The encoder engine 106 may form the TUs including the residual data for the CU, and may then transform the TUs to produce transform coefficients for the CU.

The encoder engine 106 may perform quantization of the transform coefficients. Quantization provides further compression by quantizing the transform coefficients to reduce the amount of data used to represent the coefficients. For example, quantization may reduce the bit depth associated with some or all of the coefficients. In one example, a coefficient with an n-bit value may be rounded down to an m-bit value during quantization, with n being greater than m.

Once quantization is performed, the coded bitstream includes quantized transform coefficients, prediction information (e.g., prediction modes, motion vectors, or the like), partitioning information, and any other suitable data, such as other syntax data. The different elements of the coded bitstream may then be entropy encoded by the encoder engine 106. In some examples, the encoder engine 106 may utilize a predefined scan order to scan the quantized transform coefficients to produce a serialized vector that can be entropy encoded. In some examples, encoder engine 106 may perform an adaptive scan. After scanning the quantized transform coefficients to form a one-dimensional vector, the encoder engine 106 may entropy encode the one-dimensional vector. For example, the encoder engine 106 may use context adaptive variable length coding, context adaptive binary arithmetic coding, syntax-based context-adaptive binary arithmetic coding, probability interval partitioning entropy coding, or another suitable entropy encoding technique.

At least some of the operations described above in connection with the encoder engine 106 may result in the presence of visual artifacts, and particularly, banding artifacts or contouring artifacts. Therefore, video images in the encoded video data of an output bitstream (e.g., an HEVC bitstream having one or more CVSs including NAL units) may contain banding artifacts that need to be corrected. The correction of banding artifacts may involve removing or reducing a banding artifact such that the banding artifact is not noticeable (or barely noticeable) to a viewer.

The output 110 of the encoding device 104 may send the NAL units making up the encoded video data over the communications link 120 (e.g., communication links 125 in FIG. 1B) to the decoding device 112 of the receiving device. The input 114 of the decoding device 112 may receive the NAL units. The communications link 120 may include a signal transmitted using a wireless network, a wired network, or a combination of a wired and wireless network. A wireless network may include any wireless interface or combination of wireless interfaces and may include any suitable wireless network (e.g., the internet or other wide area network, a packet-based network, WiFi™, radio frequency (RF), UWB, WiFi-Direct, cellular, Long-Term Evolution (LTE), WiMax™, or the like). An example of a wireless network is illustrated in FIG. 1B. A wired network may include any wired interface (e.g., fiber, ethernet, powerline ethernet, ethernet over coaxial cable, digital signal line (DSL), or the like). The wired and/or wireless networks may be implemented using various equipment, such as base stations, routers, access points, bridges, gateways, switches, or the like. The encoded video data may be modulated according to a communication standard, such as a wireless communication protocol, and transmitted to the receiving device.

In some examples, the encoding device 104 may store encoded video data in storage 108. The output 110 may retrieve the encoded video data from the encoder engine 106 or from the storage 108. The storage 108 may include any of a variety of distributed or locally accessed data storage media. For example, the storage 108 may include a hard drive, a storage disc, flash memory, volatile or non-volatile memory, or any other suitable digital storage media for storing encoded video data. Although shown as separate from the encoder engine 106, the storage 108, or at least part of the storage 108, may be implemented as part of the encoder engine 106.

The input 114 receives the encoded video data and may provide the video data to the decoder engine 116 (or decoder) or to the storage 118 for later use by the decoder engine 116. The decoder engine 116 may decode the encoded video data by entropy decoding (e.g., using an entropy decoder) and extracting the elements of the coded video sequence making up the encoded video data. The decoder engine 116 may then rescale and perform an inverse transform on the encoded video data. Residues are then passed to a prediction stage of the decoder engine 116. The decoder engine 116 may then predict a block of pixels (e.g., a PU). In some examples, the prediction is added to the output of the inverse transform.

The decoding device 112 may output the decoded video to a video destination device 122, which may include a display or other output device for displaying the decoded video data to a consumer of the content. In some aspects, the video destination device 122 may be part of the receiving device that includes the decoding device 112. In some aspects, the video destination device 122 may be part of a separate device other than the receiving device.

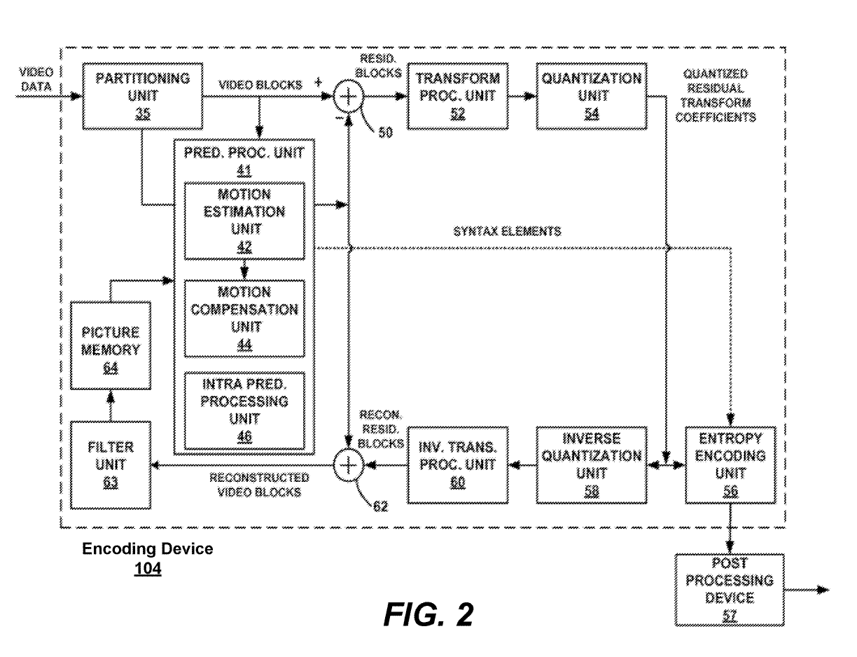

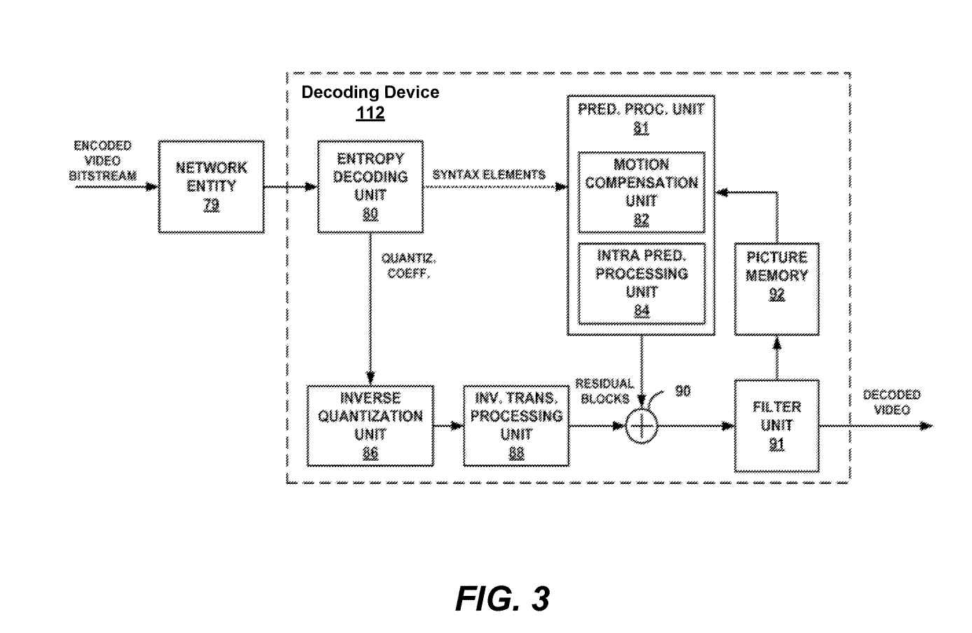

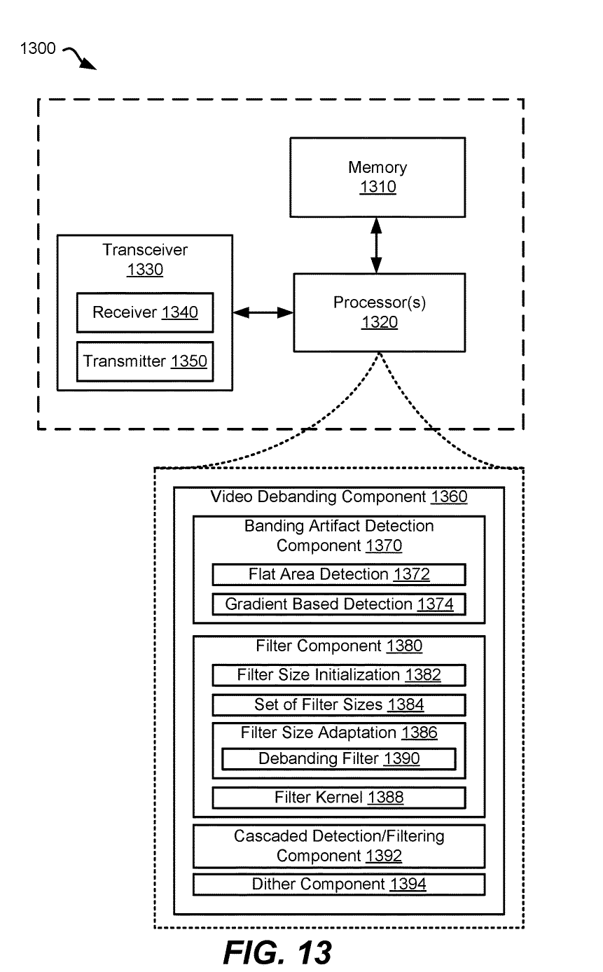

In some aspects, the encoding device 104 and/or the decoding device 112 may be integrated with an audio encoding device and audio decoding device, respectively. The encoding device 104 and/or the decoding device 112 may also include other hardware or software that is necessary to implement the coding techniques described above, such as one or more microprocessors, digital signal processors (DSPs), application specific integrated circuits (ASICs), field programmable gate arrays (FPGAs), discrete logic, software, hardware, firmware or any combinations thereof. The encoding device 104 and the decoding device 112 may be integrated as part of a combined encoder/decoder (codec) in a respective device. An example of specific details of the encoding device 104 is described below with reference to FIG. 2. An example of specific details of the decoding device 112 is described below with reference to FIG. 3. Additionally, aspects of the hardware implementation of the decoding device 112 or of a video debanding component in a device, such as a wireless communication device, are described in more detail below with respect to FIG. 13.

FIG. 1B shows a wireless network 130 that includes a base station 105 and wireless communication devices 115-a and 115-b. The wireless network 130 may represent a portion of the system 100 in FIG. 1A. As described above, encoded video data may be transmitted over a wireless network such as the wireless network 130.

The base station 105 provides a coverage 140 that allows both wireless communication devices 115-a and 115-b to communicate with the base station 105 using communication links 125. The wireless communication devices 115-a and 115-b may communicate with each other through the base station 105 or may be able to communicate with a destination device through the base station 105. Communications by the wireless communication devices 115-a and 115-b may use signals that are configured and processed (e.g., modulated) in accordance with a cellular communication standard, or some other wireless communication standard. In one example, one of the wireless communication devices 115-a and 115-b may communicate with another wireless communication device under the coverage of a different base station by having that base station communicate with the base station 105. In another example, one of the wireless communication devices 115-a and 115-b may communicate with a server, a database, a network storage device, or any other type of non-mobile destination device through the base station 105.

In one scenario, either the wireless communication device 115-a or the wireless communication device 115-b may operate as a source device. In such a scenario, the wireless communication device may encode video data using the encoding device 104 that is part of the wireless communication device. The encoded video data may be transmitted via the wireless network 130 to a destination device. The encoded video data may contain banding artifacts caused by, for example, limited bit depth, post-processing filtering at the encoding device 104, and/or video compression operations at the encoding device 104. These banding artifacts may require processing at the receiving or destination device to remove or reduce the visual effects caused by the presence of the banding artifacts.

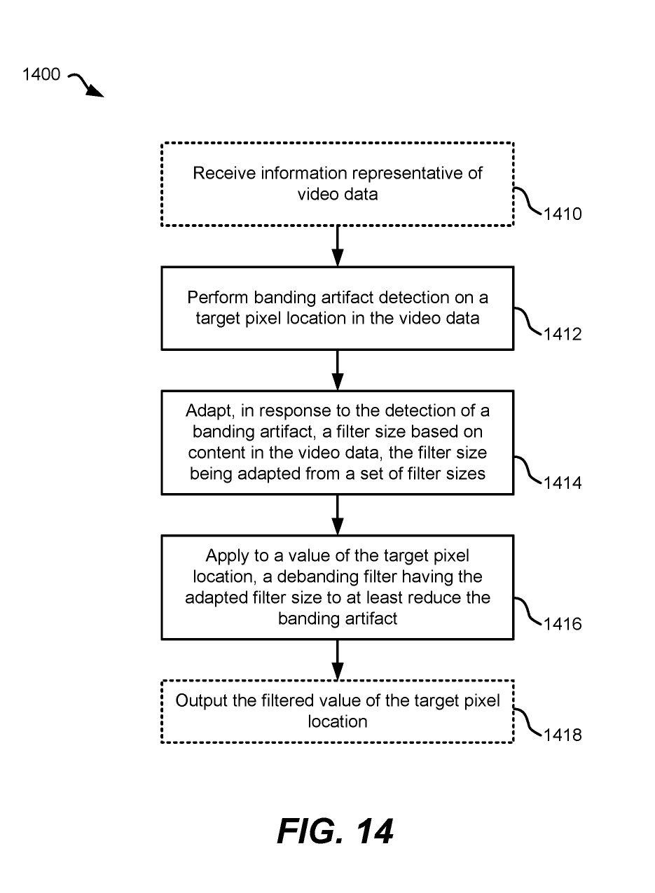

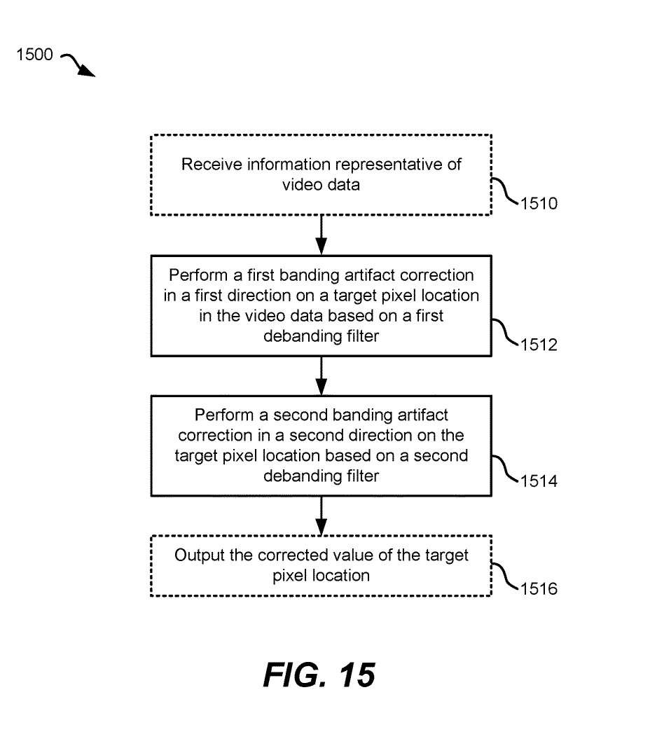

In another scenario, either the wireless communication device 115-a or the wireless communication device 115-b may operate as a receiving or destination device. In such a scenario, the wireless communication device may decode video data and perform video debanding based on the techniques described herein (e.g., FIGS. 14 and 15) using the decoding device 112 that is part of the wireless communication device. For example, the decoding device 112 may include a video debanding component 1360 (see e.g., FIG. 13) that is configured to perform video debanding. In some instances, the video debanding component 1360 may be implemented separately from the decoding device 112. The encoded video data with the banding artifacts may be received via the wireless network 130 from a source device.

In yet another scenario, the wireless communication device 115-a may operate as a source device and the wireless communication device 115-b may operate as a receiving or destination device. In such a scenario, the wireless communication device 115-a may encode video data using the encoding device 104 that is part of the wireless communication device 115-a, where the encoded video data may contain banding artifacts, and the wireless communication device 115-b may decode the encoded video data and perform video debanding based on the techniques described herein (e.g., FIGS. 14 and 15) using the decoding device 112 that is part of the wireless communication device 115-b. For example, the decoding device 112 may include a video debanding component 1360 (see e.g., FIG. 13) that is configured to perform video debanding. In some instances, the video debanding component 1360 may be implemented separately from the decoding device 112.

The scenarios described above have been provided by way of illustration and are not intended to be limiting. Other scenarios may be described where a device that generates encoded video data (e.g., video images) having banding artifacts is a wireless communication device. Moreover, other scenarios may be described where a wireless communication device receives encoded video data (e.g., video images) having banding artifacts and is capable of performing video debanding to correct for the presence of the banding artifacts.

Referring to FIG. 2, a block diagram illustrating an example of the video encoding device 104 in FIGS. 1A and 1B. The encoding device 104 may, for example, perform encoding operations and may generate syntax structures (e.g., syntax elements). The encoding device 104 may perform intra-prediction and inter-prediction coding of video data (e.g., video blocks) within video slices. Intra-coding relies, at least in part, on spatial prediction to reduce or remove spatial redundancy within a given video frame or picture. Inter-coding relies, at least in part, on temporal prediction to reduce or remove temporal redundancy within adjacent or surrounding frames of a video sequence. Intra-mode (I mode) may refer to any of several spatial based compression modes. Inter-modes, such as uni-directional prediction (P mode) or bi-prediction (B mode) described above, may refer to any of several temporal-based compression modes.

The encoding device 104 includes a partitioning unit 35, a prediction processing unit 41, a filter unit 63, a picture memory 64, a summer 50, a transform processing unit 52, a quantization unit 54, and an entropy encoding unit 56. The prediction processing unit 41 includes a motion estimation unit 42, a motion compensation unit 44, and an intra-prediction processing unit 46. For video block reconstruction, the encoding device 104 also includes an inverse quantization unit 58, an inverse transform processing unit 60, and a summer 62. The filter unit 63 is intended to represent one or more loop filters such as a deblocking filter, an adaptive loop filter (ALF), and a sample adaptive offset (SAO) filter. Although the filter unit 63 is shown in FIG. 2 as being an in loop filter, in other configurations, the filter unit 63 may be implemented as a post loop filter. A post processing device 57 may perform additional processing on encoded video data generated by the encoding device 104. The techniques of this disclosure may, in some instances, be implemented by the encoding device 104 in, for example, the post processing device 57.

As shown in FIG. 2, the encoding device 104 receives video data, and the partitioning unit 35 partitions the data into video blocks. The partitioning may also include partitioning into slices, slice segments, tiles, or other larger units, as wells as video block partitioning, e.g., according to a quadtree structure of largest coding units (LCUs) and CUs. The encoding device 104 generally illustrates the components that encode video blocks within a video slice to be encoded. The slice may be divided into multiple video blocks (and possibly into sets of video blocks referred to as tiles). The prediction processing unit 41 may select one of a plurality of possible coding modes, such as one of a plurality of intra-prediction coding modes or one of a plurality of inter-prediction coding modes, for the current video block based on error results (e.g., coding rate and the level of distortion, or the like). The prediction processing unit 41 may provide the resulting intra- or inter-coded block to the summer 50 to generate residual block data and to the summer 62 to reconstruct the encoded block for use as a reference picture.

The intra-prediction processing unit 46 within the prediction processing unit 41 may perform intra-prediction coding of the current video block relative to one or more neighboring blocks in the same frame or slice as the current block to be coded to provide spatial compression. The motion estimation unit 42 and the motion compensation unit 44 within the prediction processing unit 41 perform inter-predictive coding of the current video block relative to one or more predictive blocks in one or more reference pictures to provide temporal compression.

The motion estimation unit 42 may be configured to determine the inter-prediction mode for a video slice according to a predetermined pattern for a video sequence. The predetermined pattern may designate video slices in the sequence as P slices, B slices, or GPB slices. The motion estimation unit 42 and the motion compensation unit 44 may be highly integrated, but are illustrated separately for conceptual purposes. The motion estimation, performed by the motion estimation unit 42, is the process of generating motion vectors, which estimate motion for video blocks. A motion vector, for example, may indicate the displacement of a prediction unit (PU) of a video block within a current video frame or picture relative to a predictive block within a reference picture.

A predictive block is a block that is found to closely match the PU of the video block to be coded in terms of pixel difference, which may be determined by sum of absolute difference (SAD), sum of square difference (SSD), or other difference metrics. In some examples, the encoding device 104 may calculate values for sub-integer pixel positions of reference pictures stored in the picture memory 64. For example, the encoding device 104 may interpolate values of one-quarter pixel positions, one-eighth pixel positions, or other fractional pixel positions of the reference picture. Therefore, the motion estimation unit 42 may perform a motion search relative to the full pixel positions and fractional pixel positions and output a motion vector with fractional pixel precision.

The motion estimation unit 42 calculates a motion vector for a PU of a video block in an inter-coded slice by comparing the position of the PU to the position of a predictive block of a reference picture. The reference picture may be selected from a first reference picture list (List 0) or a second reference picture list (List 1), each of which identify one or more reference pictures stored in the picture memory 64. The motion estimation unit 42 sends the calculated motion vector to the entropy encoding unit 56 and the motion compensation unit 44.

The motion compensation, performed by the motion compensation unit 44, may involve fetching or generating the predictive block based on the motion vector determined by motion estimation, possibly performing interpolations to sub-pixel precision. Upon receiving the motion vector for the PU of the current video block, the motion compensation unit 44 may locate the predictive block to which the motion vector points in a reference picture list. The encoding device 104 forms a residual video block by subtracting pixel values of the predictive block from the pixel values of the current video block being coded, forming pixel difference values. The pixel difference values form residual data for the block, and may include both luma and chroma difference components. The summer 50 represents the component or components that perform this subtraction operation. The motion compensation unit 44 may also generate syntax elements associated with the video blocks and the video slice for use by the decoding device 112 in decoding the video blocks of the video slice.

The intra-prediction processing unit 46 may intra-predict a current block, as an alternative to the inter-prediction performed by the motion estimation unit 42 and the motion compensation unit 44, as described above. In particular, the intra-prediction processing unit 46 may determine an intra-prediction mode to use to encode a current block. In some examples, the intra-prediction processing unit 46 may encode a current block using various intra-prediction modes, e.g., during separate encoding passes, and the intra-prediction unit processing 46 may select an appropriate intra-prediction mode to use from the tested modes. For example, the intra-prediction processing unit 46 may calculate rate-distortion values using a rate-distortion analysis for the various tested intra-prediction modes, and may select the intra-prediction mode having the best rate-distortion characteristics among the tested modes. Rate-distortion analysis generally determines an amount of distortion (or error) between an encoded block and an original, unencoded block that was encoded to produce the encoded block, as well as a bit rate (that is, a number of bits) used to produce the encoded block. The intra-prediction processing unit 46 may calculate ratios from the distortions and rates for the various encoded blocks to determine which intra-prediction mode exhibits the best rate-distortion value for the block.

After selecting an intra-prediction mode for a block, the intra-prediction processing unit 46 may provide information indicative of the selected intra-prediction mode for the block to the entropy encoding unit 56. The entropy encoding unit 56 may encode the information indicating the selected intra-prediction mode. The encoding device 104 may include in the transmitted bitstream configuration data definitions of encoding contexts for various blocks as well as indications of a most probable intra-prediction mode, an intra-prediction mode index table, and a modified intra-prediction mode index table to use for each of the contexts. The bitstream configuration data may include a plurality of intra-prediction mode index tables and a plurality of modified intra-prediction mode index tables (also referred to as codeword mapping tables).

After the prediction processing unit 41 generates the predictive block for the current video block via either inter-prediction or intra-prediction, the encoding device 104 forms a residual video block by subtracting the predictive block from the current video block. The residual video data in the residual block may be included in one or more TUs and applied to the transform processing unit 52. The transform processing unit 52 transforms the residual video data into residual transform coefficients using a transform, such as a discrete cosine transform (DCT) or a conceptually similar transform. The transform processing unit 52 may convert the residual video data from a pixel domain to a transform domain, such as a frequency domain.

The transform processing unit 52 may send the resulting transform coefficients to quantization unit 54. The quantization unit 54 quantizes the transform coefficients to further reduce bit rate. The quantization process may reduce the bit depth associated with some or all of the coefficients. The degree of quantization may be modified by adjusting a quantization parameter. In some examples, the quantization unit 54 may then perform a scan of the matrix including the quantized transform coefficients. Alternatively, the entropy encoding unit 56 may perform the scan.

Following quantization, the entropy encoding unit 56 entropy encodes the quantized transform coefficients. For example, the entropy encoding unit 56 may perform context adaptive variable length coding (CAVLC), context adaptive binary arithmetic coding (CABAC), syntax-based context-adaptive binary arithmetic coding (SBAC), probability interval partitioning entropy (PIPE) coding or another entropy encoding technique. Following the entropy encoding by the entropy encoding unit 56, the encoded bitstream may be transmitted to the decoding device 112, or archived for later transmission or retrieval by the decoding device 112. Video images in the encoded bitstream may include banding artifacts and the decoding device 112 may include or be connected to a component configured to remove or reduce those banding artifacts. The entropy encoding unit 56 may also entropy encode the motion vectors and the other syntax elements for the current video slice being coded.

The inverse quantization unit 58 and the inverse transform processing unit 60 apply inverse quantization and inverse transformation, respectively, to reconstruct the residual block in the pixel domain for later use as a reference block of a reference picture. Motion compensation unit 44 may calculate a reference block by adding the residual block to a predictive block of one of the reference pictures within a reference picture list. The motion compensation unit 44 may also apply one or more interpolation filters to the reconstructed residual block to calculate sub-integer pixel values for use in motion estimation. The summer 62 adds the reconstructed residual block to the motion compensated prediction block produced by motion compensation unit 44 to produce a reference block for storage in the picture memory 64. The reference block may be used by the motion estimation unit 42 and the motion compensation unit 44 as a reference block to inter-predict a block in a subsequent video frame or picture.

Additional details related to the decoding device 112 are provided below with reference to FIG. 3. The decoding device 112 includes an entropy decoding unit 80, a prediction processing unit 81, an inverse quantization unit 86, an inverse transform processing unit 88, a summer 90, a filter unit 91, and a picture memory 92. The prediction processing unit 81 includes a motion compensation unit 82 and an intra prediction processing unit 84. The decoding device 112 may, in some examples, perform a decoding pass generally reciprocal to the encoding pass described with respect to the encoding device 104 from FIG. 2.

During the decoding process, the decoding device 112 receives an encoded video bitstream that represents video blocks of an encoded video slice and associated syntax elements sent by the encoding device 104. The decoding device 112 may receive the encoded video bitstream from the encoding device 104 or may receive the encoded video bitstream from a network entity 79, such as a server, a media-aware network element (MANE), a video editor/splicer, or other such device configured to implement one or more of the techniques described above. Network entity 79 may or may not include the encoding device 104. In some video decoding systems, the network entity 79 and the decoding device 112 may be parts of separate devices, while in other instances, the functionality described with respect to the network entity 79 may be performed by the same device that comprises the decoding device 112.

The entropy decoding unit 80 of the decoding device 112 entropy decodes the bitstream to generate quantized coefficients, motion vectors, and other syntax elements. The entropy decoding unit 80 forwards the motion vectors and other syntax elements to the prediction processing unit 81. The decoding device 112 may receive the syntax elements at the video slice level and/or the video block level. The entropy decoding unit 80 may process and parse both fixed-length syntax elements and variable-length syntax elements.

When the video slice is coded as an intra-coded (I) slice, the intra prediction processing unit 84 of the prediction processing unit 81 may generate prediction data for a video block of the current video slice based on a signaled intra-prediction mode and data from previously decoded blocks of the current frame or picture. When the video frame is coded as an inter-coded (i.e., B, P or GPB) slice, the motion compensation unit 82 of the prediction processing unit 81 produces predictive blocks for a video block of the current video slice based on the motion vectors and other syntax elements received from the entropy decoding unit 80. The predictive blocks may be produced from one of the reference pictures within a reference picture list. The decoding device 112 may construct the reference frame lists, List 0 and List 1, using default construction techniques based on reference pictures stored in the picture memory 92.

The motion compensation unit 82 determines prediction information for a video block of the current video slice by parsing the motion vectors and other syntax elements, and uses the prediction information to produce the predictive blocks for the current video block being decoded. For example, the motion compensation unit 82 may use one or more syntax elements in a parameter set to determine a prediction mode (e.g., intra- or inter-prediction) used to code the video blocks of the video slice, an inter-prediction slice type (e.g., B slice, P slice, or GPB slice), construction information for one or more reference picture lists for the slice, motion vectors for each inter-encoded video block of the slice, inter-prediction status for each inter-coded video block of the slice, and other information to decode the video blocks in the current video slice.

The motion compensation unit 82 may also perform interpolation based on interpolation filters. The motion compensation unit 82 may use interpolation filters as used by the encoding device 104 during encoding of the video blocks to calculate interpolated values for sub-integer pixels of reference blocks. In this case, the motion compensation unit 82 may determine the interpolation filters used by the encoding device 104 from the received syntax elements, and may use the interpolation filters to produce predictive blocks.

The inverse quantization unit 86 inverse quantizes, or de-quantizes, the quantized transform coefficients provided in the bitstream and decoded by entropy decoding unit 80. The inverse quantization process may include use of a quantization parameter calculated by the encoding device 104 for each video block in the video slice to determine a degree of quantization and, likewise, a degree of inverse quantization that should be applied. The inverse transform processing unit 88 applies an inverse transform (e.g., an inverse DCT or other suitable inverse transform), an inverse integer transform, or a conceptually similar inverse transform process, to the transform coefficients in order to produce residual blocks in the pixel domain.

After the motion compensation unit 82 generates the predictive block for the current video block based on the motion vectors and other syntax elements, the decoding device 112 forms a decoded video block by summing the residual blocks from the inverse transform processing unit 88 with the corresponding predictive blocks generated by the motion compensation unit 82. The summer 90 represents the component or components that perform this summation operation. If desired, loop filters (either in the coding loop or after the coding loop) may also be used to smooth pixel transitions, or to otherwise improve the video quality. The filter unit 91 is intended to represent one or more loop filters such as a deblocking filter, an adaptive loop filter (ALF), and a sample adaptive offset (SAO) filter. Although the filter unit 91 is shown in FIG. 3 as being an in loop filter, in other configurations, the filter unit 91 may be implemented as a post loop filter. The decoded video blocks in a given frame or picture are then stored in the picture memory 92, which stores reference pictures used for subsequent motion compensation. The picture memory 92 also stores decoded video for later presentation on a display device, such as video destination device 122 shown in FIG. 1A.

The video debanding techniques of this disclosure may be performed by a video decoding device such as the decoding device 112, or by a video encoder/decoder, typically referred to as a “CODEC.” Moreover, the video debanding techniques of this disclosure may also be performed by a video preprocessor (see e.g., processor(s) 1320 in FIG. 13). In some instances, video debanding may be performed after the decoding device 112, the video encoder/decoder, or the video processor receives and decodes encoded video data.

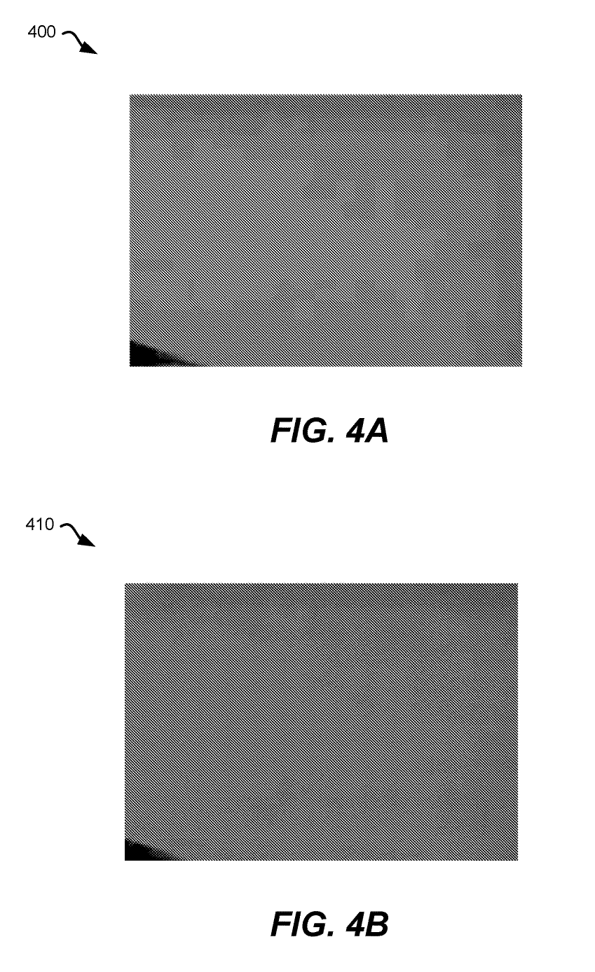

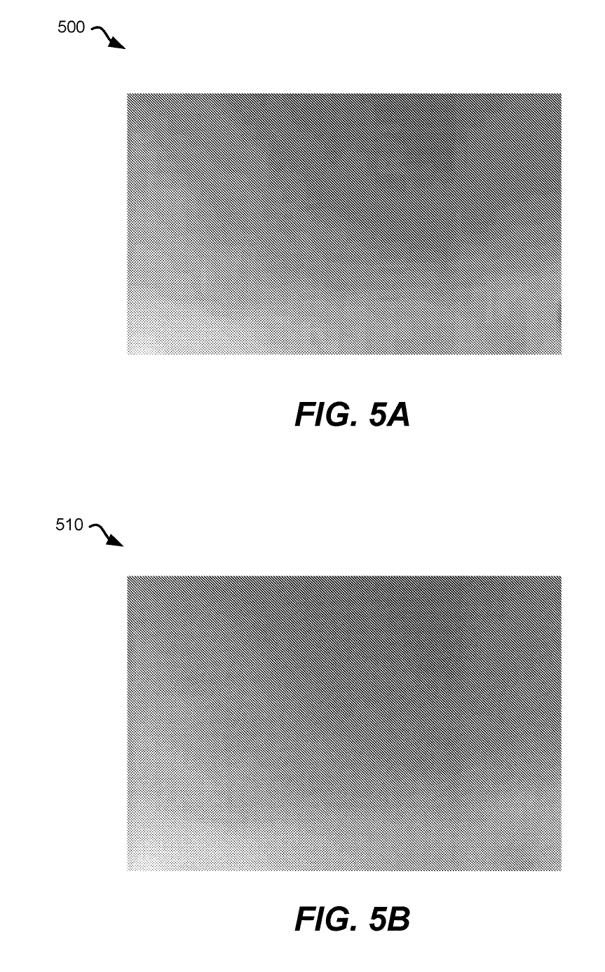

Referring to FIG. 4A, there is shown an image 400 that is an original image having banding artifacts in an area or region with slow changing gradients or ramps (e.g., areas or regions with small slopes in pixel values). Such an area or region may be referred to as a low texture or flat area or region. The image 400 may be a decoded video image that shows banding artifacts. FIG. 4B shows an image 410 that represents the image 400 after debanding (e.g., after performing video debanding). Similarly, FIG. 5A shows an original image 500 and FIG. 5B shows an image 510 that represents the image 500 after debanding. Images 410 and 510 are perceived to have better video quality because the banding artifacts have been removed or reduced. Therefore, performing video debanding operations on video images (e.g., encoded video images) that have banding artifacts improves the overall experience of the viewer as banding artifacts are generally correlated by the viewer with poor video quality.

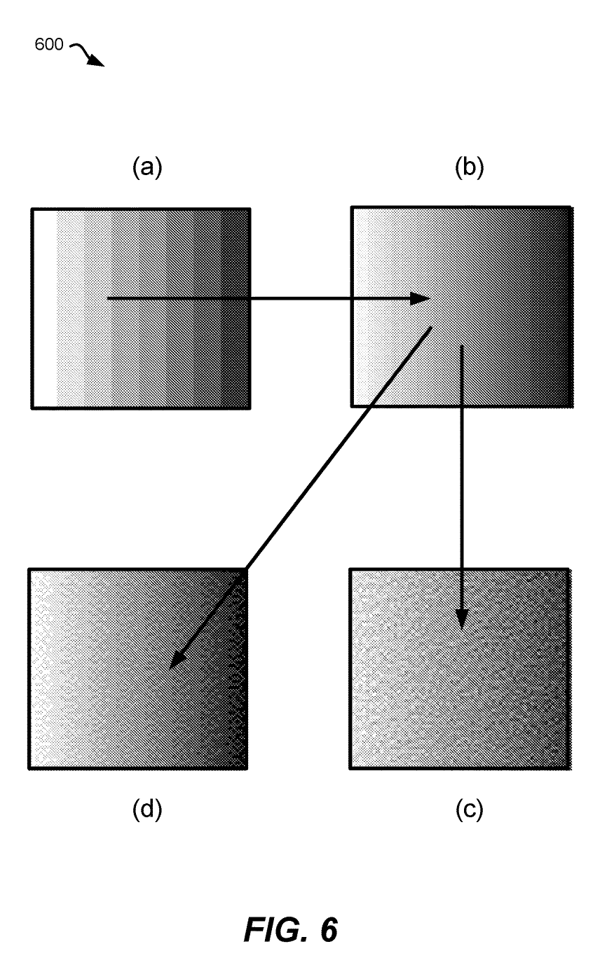

As described above, current solutions for video debanding may have some limitations. These solutions are based on some general operations. FIG. 6 shows a diagram 600 that illustrates examples of these operations. At first, banding detection (a) is performed to identify areas or regions with banding artifacts. The video image in FIG. 6 shows clear vertical bands or contours (banding or contouring artifacts) that get progressively darker from left to right. Then, a smoothing filter is applied (b) that removes or reduces (e.g., softens) the contours or bands. This filtering operation generally increases the bit depth of the pixel values. In one example, the pixel values of the video image may be converted from 8-bit pixel values to 12-bit pixel values as a result of the filtering. After the filtering, an error diffusion dithering with noise injection (c) may be performed that provides conversion back to a desired bit depth. Alternatively, an error diffusion dithering without noise injection (d) may be performed that also provides conversion back to the desired bit depth. In an example, operations (c) and (d) may convert 12-bit pixel values resulting from the filtering back to 8-bit pixel values.

These general operations, however, may have at least the issues described above with respect to misdetection or misidentification of banding artifacts, the use of large, fixed filter sizes, and artifacts being caused by the abrupt transition between areas where filtering is applied and areas where filtering is not applied.

To overcome these limitations, the proposed video debanding solution involves various features. For example, the proposed video debanding solution includes the use of separable one-dimensional (1D) filters. These filters may be better configured for this application and be less expensive than other filters used in current solutions for video debanding. The proposed video debanding solution also includes banding detection to identify pixels that may have banding, debanding filtering (e.g., using 1D FIR filters) applied to those pixels with banding, and dithering to convert the pixel values to the appropriate bit depth (e.g., from 12-bit pixel values to 8-bit pixel values). The banding detection may include a first step or criterion to identify whether an area (multiple pixel locations in a row or column of a video image) potentially has banding, and a second step or criterion that includes an analysis of the gradients in a filter kernel associated with a debanding filter. The debanding filtering may include an adaptive approach to identify a filter size (e.g., from a set of filter sizes being supported) that provides the best result given the contents and/or the size of the contents in the video image.

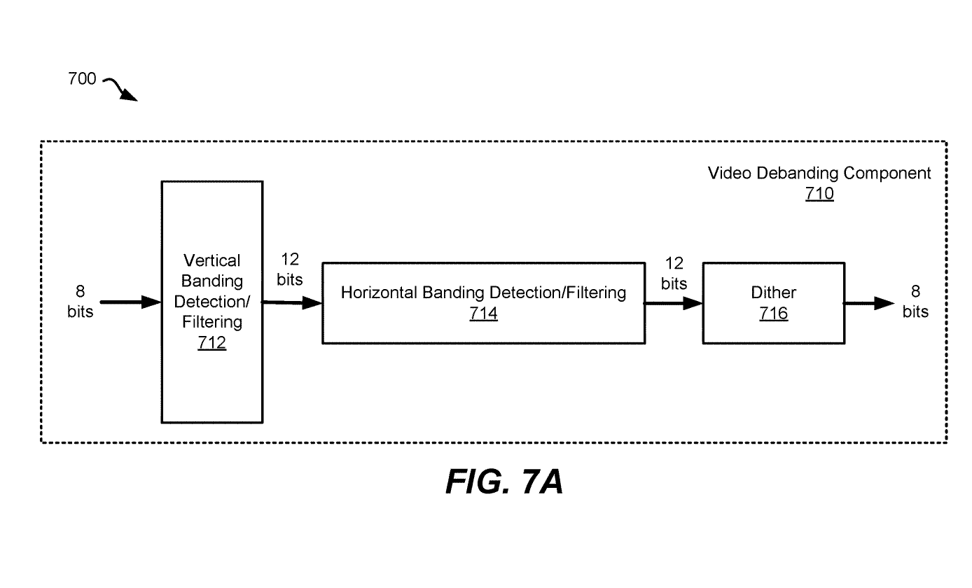

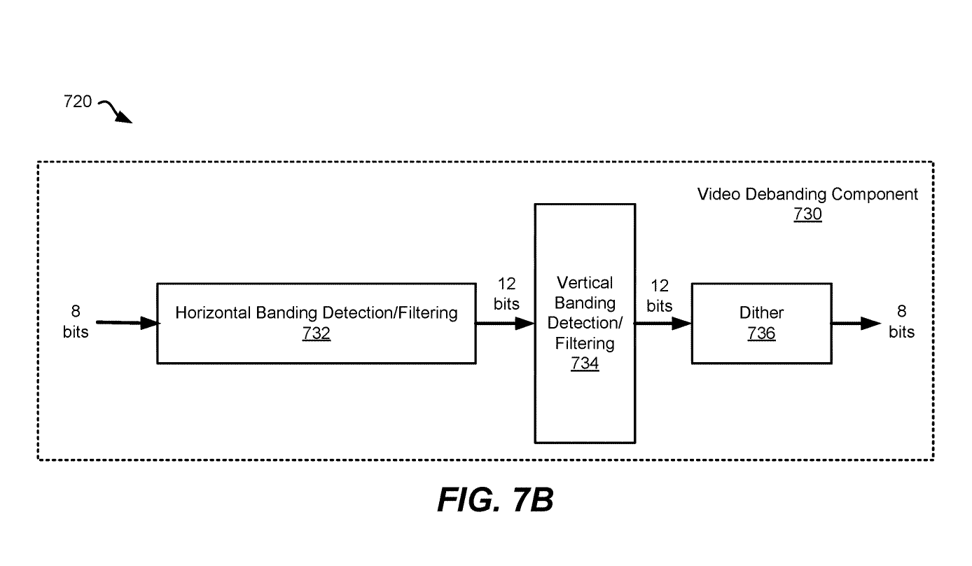

The proposed video debanding solution may be performed in one direction of the video image and subsequently in a different direction by using separable 1D filters. That is, video debanding may be cascaded by first applying video debanding in one direction to produce a first filtered video image and then applying video debanding in a different direction to the first filtered video image to produce a second filtered video image. In an example, video debanding may be first performed or applied in a vertical direction (e.g., in columns of pixels) to produce a vertically filtered video image as described in more detail below with respect to FIG. 7A. Video debanding may be subsequently performed or applied to the vertically filtered video image in a horizontal direction (e.g., in rows of pixels) to produce a horizontally filtered video image. In another example, video debanding may be first performed or applied in a horizontal direction (e.g., in rows of pixels) to produce a horizontally filtered video image as described in more detail below with respect to FIG. 7B. Video debanding may be subsequently performed or applied to the horizontally filtered video image in a vertical direction (e.g., in columns of pixels) to produce a vertically filtered video image. Cascading or serializing the video debanding in this fashion may allow for video debanding to account for the differences in the type and/or size of banding artifacts in the horizontal and vertical directions.

Referring to FIG. 7A, a block diagram 700 is shown that may be part of a video debanding component 710 (e.g., video debanding component 1360 in FIG. 13). The video debanding component 710 may be part of, for example, the decoding device 112, a video encoder/decoder (CODEC), a video processor, or a processor like the processor(s) 1320 in FIG. 13. The video debanding component 710 may be configured to cascade two consecutive video debanding operations, where a first video debanding is performed or applied in a vertical direction and a second video debanding is performed or applied in a horizontal direction.

The video debanding component 710 may perform various aspects described herein for video debanding that uses adaptive filter sizes and gradient based banding detection (also referred to as gradient based banding artifact detection). For example, the video debanding component 710 may receive image data in the form of decoded video images, where the image data may have pixel values of a first bit depth. In an example, the bit depth may be 8 bits since this is a typical number of bits used to represent colors and/or intensity levels in a pixel for display and/or storage purposes.

The video data may be first processed by a vertical banding detection/filtering 712 implemented as hardware, software, or a combination of both. The vertical banding detection/filtering 712 may perform banding detection (e.g., banding artifact detection) in the vertical direction to detect or identify pixels with banding. A pixel with banding may refer to a pixel (or pixel location) having a banding artifact or a pixel (or pixel location) that is part of a region having a banding artifact. As described herein, a reference to a pixel in a video image may indicate a reference to the value of the pixel or to the pixel location, as appropriate. The banding detection may include a first step or criterion in which it is determined whether an area of a video image (e.g., a set/group of consecutive pixels or pixel locations in a column of the video image) potentially has banding; and a second step or criterion in which gradients within a filter kernel are used to determine that the area has banding.

The vertical banding detection/filtering 712 may also perform an adaptive (banding) filtering operation in which one or more filter sizes are used to filter the area with banding. In an aspect, the adaptive filtering operation may start with a first or initial filter size and may increase the filter size in accordance with the content size (e.g., the size of the banding artifact). The adaptive filtering may increase the bit depth of the pixel values in the vertically filtered video image produced by the adaptive filtering. For example, while the input video image to the vertical banding detection/filtering 712 may have pixels with 8 bit values, the output of the vertical banding detection/filtering 712 (e.g., vertically filtered video image) may have pixels with 12 bit values. The output of the vertical banding detection/filtering 712 may be referred to as a vertically filtered video image.

After the processing performed by the vertical banding detection/filtering 712, a horizontal banding detection/filtering 714 may be implemented as hardware, software, or a combination of both to further process the vertically filtered video image produced by the vertical banding detection/filtering 712. The horizontal banding detection/filtering 714 may also perform banding detection and adaptive filtering. The output of the horizontal banding detection/filtering 714 may be referred to as a horizontally filtered video image.

After the processing performed by the horizontal banding detection/filtering 714, the horizontally filtered video image may be processed by a dither 716 that may perform dithering, or dithering and noise injection, to produce a video image with removed or reduced banding artifacts. The dithering may change the bit depth to a smaller bit depth. For example, the horizontally filtered video image may have pixel values with a bit depth of 12 bits while the video image produced by the dither 716 may have pixel values with a bit depth of 8 bits.

Referring to FIG. 7B, a block diagram 720 is shown that may be part of a video debanding component 730 (e.g., video debanding component 1360 in FIG. 13). The video debanding component 730 may be part of, for example, the decoding device 112, a video encoder/decoder (CODEC), a video processor, or a processor like the processor(s) 1320 in FIG. 13. The video debanding component 730 may be configured to cascade two consecutive video debanding operations, where a first video debanding is performed or applied in a horizontal direction and a second video debanding is performed or applied in a vertical direction.

The video debanding component 730 may include a horizontal banding detection/filtering 732, a vertical banding detection/filtering 734, and a dither 736, which may be respectively configured to perform the same or similar functions to the horizontal banding detection/filtering 714, the vertical banding detection/filtering 712, and the dither 716 in FIG. 7A.

In an aspect, a video debanding component such as the video debanding component 730 may be configured to select a cascaded configuration in which horizontal banding detection and filtering is performed first and vertical banding detection and filtering is performed second, or to select a different cascaded configuration in which vertical banding detection and filtering is performed first and horizontal banding detection and filtering is performed second.

As described above, banding detection, whether performed in a horizontal direction or a vertical direction, may include a first step or criterion in which it is determined whether an area of a video image (e.g., a set/group of consecutive pixels or pixel locations in a column of the video image) potentially has banding; and a second step or criterion in which gradients within a filter kernel associated with a debanding filter are used to determine that the area has banding.

The first step of banding detection includes identifying a pixel to be filtered using a debanding filter. The identified pixel or pixel location may be referred to as the target pixel or the target pixel location. The pixel or pixel location may have a corresponding pixel value, sometimes referred to as the original pixel value, the original sample value, or simply the original sample. The original sample is filtered using the filter (and filter size) being considered for debanding filtering. For example, debanding filtering may be based on selecting a filter size to use for a 1D filter (e.g., an averaging filter) from a set of filter sizes supported by a device (e.g., the decoding device 112). In one implementation, the set of filter sizes may be based on a macroblock size used for processing image data. In H.264, for example, the macroblock size may be 16×16 and the set of filter sizes may include a 3-tap filter size, a 7-tap filter size, an 11-tap filter size, and a 15-tap filter size. This example is given by way of illustration and the possible number and sizes of filters to be considered may vary.

Returning to the first step of banding detection, as shown in Equation (1) below, a current filter size for a debanding filter (e.g., a low pass filter (LPF)) is applied to the original sample of a target pixel location (x) to produce a filtered sample (LPF(x)).

|LPF(x)−x|<α (1)

If the difference between the filtered sample and the original sample (e.g., the difference between the filtered pixel value and the original pixel value) is less than a threshold (α), then the first step is said to have been passed or met by the current size of the debanding filter. Passing the first step may indicate that the difference due to filtering is small and, therefore, due to truncation. Accordingly, passing the first step may indicate that the area is flat and potentially has banding, and that the current size of the debanding filter is good for that area. One of the benefits of the adaptive filtering technique described herein is that the largest filter size of the debanding filter that is good or appropriate for an area with banding artifacts may be obtained to produce better video debanding.

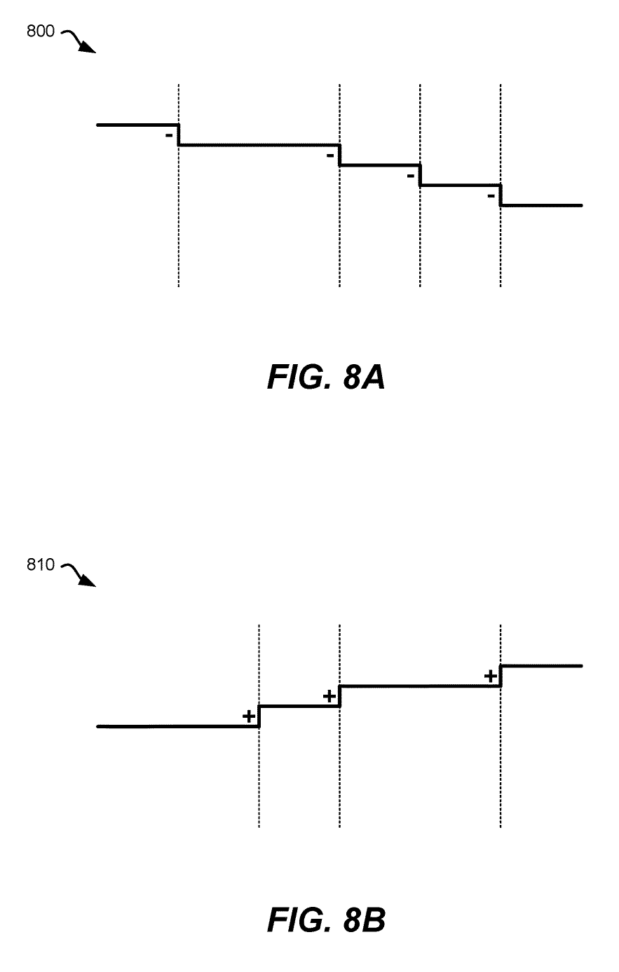

The second step of banding detection includes analyzing the area (e.g., groups of consecutive pixels in a row or column of a video image) being considered by the debanding filter to determine whether all non-zero gradients within a filter kernel have the same sign and are smaller than a threshold. A filter kernel may refer to a matrix or masking operation that is to be performed on pixels associated with a target pixel. In some instances, this threshold may be the same as the threshold (a) used in the first step of banding detection (see e.g., Equation (1)), while in other instances it may be different. Additional aspects related to the second step or action of banding detection are provided below in more detail with respect to FIGS. 8A-10.

FIG. 8A shows a diagram 800 illustrating an example where banding detection has been found to pass for a particular debanding filter size. In this example, which shows the area or region being considered within the filter kernel, there may be different gradients or ramps having the same sign. The gradients or ramps may represent areas or regions (e.g., groups of pixels or pixel locations) where the pixel values change slowly. In this example, the edges or transitions are all negative (−) and, therefore, this example is a case in which all the non-zero gradients (e.g., the transitions between flat portions of the filter kernel) have the same sign (e.g., they are all negative). A negative edge may refer to an edge (see dotted lines) in which the group of pixel to the left of the edge have a higher value than the pixels to the right of the edge. Thus, this is an example in which the second step in banding detection is found to pass or is met. Although not explicitly shown in FIG. 8A, the edges or transitions are also small enough that they are less than a threshold value. Consequently, the particular debanding filter size being considered is found suitable in this example because all non-zero gradients between values of pixel locations associated with a filter kernel have the same sign and are smaller than a threshold value.

FIG. 8B shows a diagram 810 illustrating another example where banding detection has been found to pass for a particular debanding filter size. In this example, the edges or transitions in the filter kernel are all positive (+) and, therefore, it is a case in which all the non-zero gradients (e.g., the transitions between flat portions of the filter kernel) have the same sign (e.g., they are all positive). A positive edge may refer to an edge (see dotted lines) in which the group of pixel to the left of the edge have a smaller value than the pixels to the right of the edge. Thus, in this example, the second step or action in banding detection is found to pass or be met. Although not explicitly shown in FIG. 8B, the edges or transitions are also small enough that they are less than a threshold value. Consequently, the particular debanding filter size being considered is found suitable in this example because all non-zero gradients have the same sign and are smaller than a threshold value.

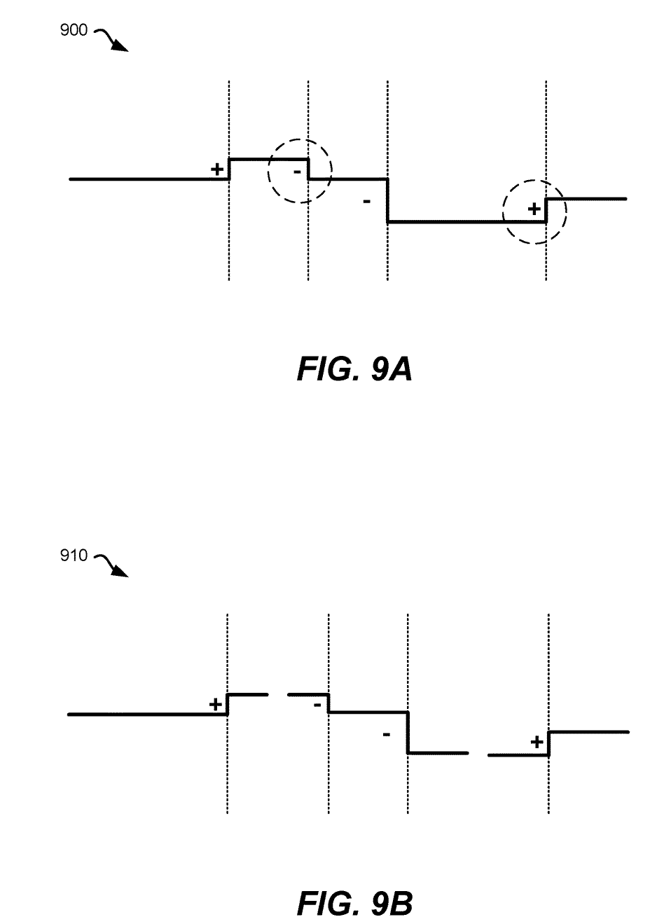

FIG. 9A shows a diagram 900 illustrating an example where banding detection has been found to fail (e.g., not to pass or not met) for a particular debanding filter size. In this example, the edges or transitions within the filter kernel have the following pattern (from left to right): positive (+), negative (−), negative (−), and positive (+). Therefore, this is a case in which some of the non-zero gradients (e.g., the transitions between flat portions of the filter kernel) have different signs. Thus, in this example, the second step in banding detection is found not to pass or not to be met. Although not explicitly shown in FIG. 9A, the edges or transitions are small enough that they are less than a threshold value. Consequently, the particular debanding filter size being considered is found not suitable in this example because, even though the non-zero gradients are smaller than a threshold value, not all of them have the same sign.

Referring to FIG. 9B, by using smaller filter sizes as shown in diagram 910, the non-zero gradients that in FIG. 9A were found to fail banding detection, may be handled differently in order to pass banding detection. In this example, the area that previously was covered by a large filter size is now covered by a smaller filter size. Accordingly, the section or portion on the left of FIG. 9B that is within a smaller filter kernel than in FIG. 9A has a single, positive (+) edge, which makes this a case in which all of the non-zero gradients have the same sign. Similarly for the section or portion on the right of FIG. 9B that is within a smaller filter kernel than in FIG. 9A. For the section or portion in the middle of FIG. 9B, there are two negative (−) edges within the smaller filter kernel, which makes this case also a case in which all of the non-zero gradients have the same sign. As illustrated by FIGS. 9A and 9B, by adapting the size of a current debanding filter (e.g., adapting the filter kernel), it is possible to find an appropriate filter size for the contents of the video image.

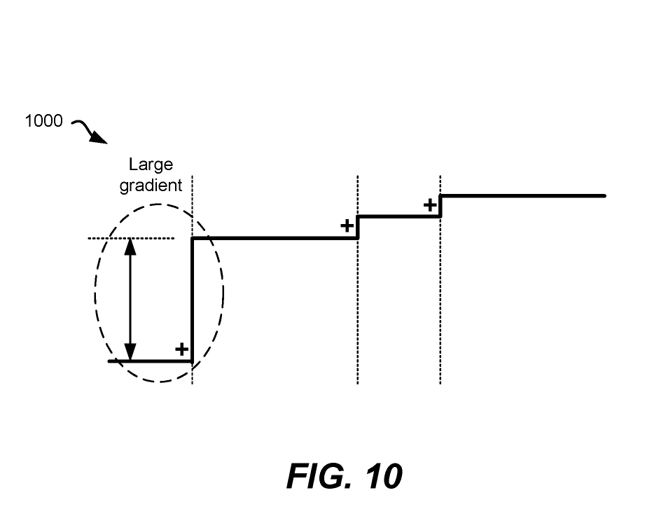

FIG. 10 shows a diagram 1000 illustrating another example where banding detection has been found to fail (e.g., not pass or not met) for a particular debanding filter size. In this example, all the non-zero gradients (e.g., the transitions between flat portions of the filter kernel) have the same sign (e.g., they are all positive (+)). However, at least one of the edges or transitions is greater than a threshold value. That is, at least one of the non-zero gradients in the filter kernel is greater than a threshold value. Consequently, the particular debanding filter size being considered is not found suitable in this example because, while all non-zero gradients have the same sign, one or more of the non-zero gradients is greater than a threshold value.

As illustrated by FIGS. 8A-10, using a debanding filter having an appropriate filter size may be helpful to have effective banding detection. For example, there may be instances in which using a smaller filer size may be more suitable to remove or reduce banding artifacts without affecting areas of a video image that do not contain banding artifacts.

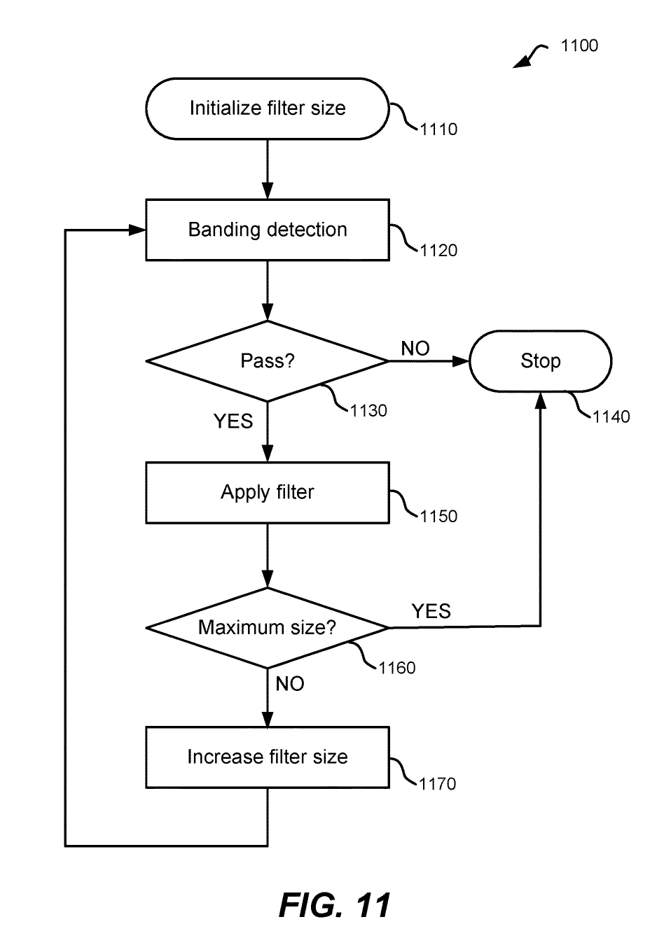

One approach to find an appropriate or suitable filter size is to use video debanding techniques that use filter size adaptation as illustrated in FIG. 11. A scheme or algorithm 1100 may be used to adapt the size of a debanding filter to an appropriate size for removing or reducing banding artifacts based on the contents and/or size of the contents of a video image. This scheme may involve both the banding detection (e.g., banding artifact detection) and the adaptive debanding filtering described above. In general, this scheme starts with a small filter size and iteratively increases the filter size until a largest, suitable filter size is identified for a particular pixel location (e.g., a target pixel location).

For example, at 1110, an initial or first filter size is selected from a set of filter sizes for the debanding filter. The filter size is first initialized to a smallest filter size from a set of filter sizes being supported. In an aspect, when the macroblock used for video processing has a 16×16 size, the set of filter sizes may include a 3-tap filter size, a 7-tap filter size, an 11-tap filter size, and a 15-tap filter size, although other macroblock sizes and/or sets of filters (e.g., different number of filter sizes in a set, different filter sizes in a set) may also be possible. As such, the initial or first filter size that is tried or tested may be the 3-tap filter size. By trying or testing the smallest filter size first, if such a filter size were to be found suitable for video debanding (e.g., passes banding detection), a larger filter size may be tried or tested next. As noted above, this process is repeated or iterated until a maximum filter size is found for a particular pixel.

At 1120, banding detection is applied using the current size of the debanding filter as initialized in 1110. As described above, banding detection has two steps or criteria that need to be met in order to find that a particular filter size for a debanding filter meets or passes banding detection. The first step is to ensure that the difference between the filtered sample of a target pixel or pixel location and the original sample of the target pixel or pixel location (e.g., the difference between the filtered pixel value and the original pixel value) is less than a threshold (a), as described above with respect to Equation (1). The second step involves having all the non-zero gradients in the filter kernel have a same sign (e.g., all positive or all negative) and having none of the non-zero gradients being greater than a threshold value.

If both steps of banding detection are met, then the current filter size for the debanding filter passes banding detection at 1130, and the scheme proceeds to 1150 where the debanding filter having the current filter size is applied to the target pixel. If at least one of the steps of banding detection is not met, then the current filter size for the debanding filter fails banding detection at 1130, and the scheme proceeds to 1140 where it stops. In the case where the current filter size is the smallest of the filter sizes in the set of filter sizes when the scheme reaches 1140, then none of the filter sizes supported was found to be suitable for the debanding filter.

After applying the debanding filter using the current filter size at 1150, the current size of the debanding filter is checked at 1160 to determine whether it is the maximum or largest filter size in the set of filter sizes. If the current filter size is the maximum or largest filter size, then the scheme proceeds to 1140 where it stops. If the current filter size is not the maximum or largest filter size, the scheme proceeds to 1170 where the size of the filter is increased to a next filter size in the set of filter sizes. For example, if the current filter size is the 3-tap filter size, the next filter size at 1170 may be the 5-tap filter size, which then becomes the current filter size. After 1170, the scheme returns to 1120 where the current filter size is again tested for banding detection.

With the approach outlined in the scheme or algorithm 1100, it is possible to determine, on a per pixel basis, the largest filter size for the debanding filter such that the debanding filter is adapted to the contents and/or size of the contents in the video image. Moreover, this scheme may be used as part of video debanding in the horizontal direction or the vertical direction.

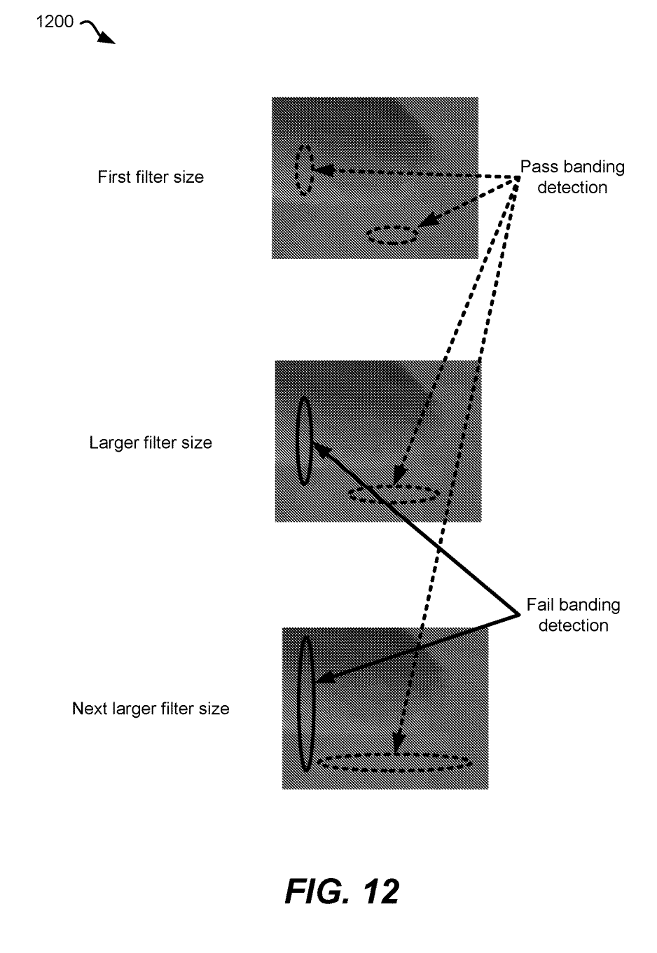

FIG. 12 shows a diagram 1200 illustrating an example of filter size adaptation based on the scheme or algorithm 1100 described above in connection with FIG. 11. Filter size adaptation may be performed during video debanding in a horizontal direction and during video debanding in a vertical direction, with the understanding that video debanding may be cascaded such that it is performed first in one direction (e.g., vertical or horizontal) and then in the other direction (e.g., horizontal or vertical).

According to diagram 1200, a first filter size may be used for a debanding filter that is to be applied to a target pixel in a vertical direction as shown in the top image of diagram 1200. In an example in which a set of filter sizes includes three filter sizes, such as 3-tap filter size, 7-tap filter size, and 11-tap filter size, the first filter size may correspond to the 3-tap filter size. The first filter size in the vertical direction is found to pass banding detection (e.g., passes both steps/criteria of banding detection), as illustrated by the dashed lines. As such, the filter size may be increased to a larger filter size as shown in the middle image. In the example described above with three filter sizes, the larger filter size may correspond to the 7-tap filter size. This larger filter size in the vertical direction, however, fails banding detection (e.g., fails one or both steps/criteria of banding detection), as illustrated by the solid lines. Accordingly, the maximum or largest filter size that may be used to filter the target pixel in the vertical direction is the first filter size. A next larger filter size in the vertical direction, one that is larger than the larger filter size, is illustrated in the bottom image. In the example described above with three filter sizes, the next larger filter size may correspond to the 11-tap filter size. This next larger filter size would also fail banding detection but it may not be necessary to try or test such a filter size since the larger filter size in the middle image was already found to fail banding detection.

Similarly, a first filter size is used for a debanding filter that is to be applied to a target pixel in a horizontal direction as shown in the top image. The first filter size in the horizontal direction may be the same or different than the first filter size in the vertical direction. The first filter size in the horizontal direction is also found to pass banding detection (e.g., passes both steps/criteria of banding detection), as illustrated by the dashed lines. As such, the filter size may be increased to a larger filter size in the horizontal direction as shown in the middle image. The larger filter size in the horizontal direction may be the same or different than the larger filter size in the vertical direction. In this example, the larger filter size in the horizontal direction also passes banding detection, as illustrated by the dashed lines. Accordingly, the filter size in the horizontal direction may be increased again to a next larger filter as shown in the bottom image. The next larger filter size in the horizontal direction may be the same or different than the next larger filter size in the vertical direction. In this example, the next larger filter size in the horizontal direction also passes banding detection, as illustrated by the dashed lines. Therefore, the largest filter size in the horizontal direction that may be used to filter the target pixel is the next larger filter size. In an example, when the set of filter sizes includes three filter sizes, such as 3-tap filter size, 7-tap filter size, and 11-tap filter size, the filter size to be used for video debanding in the horizontal direction may be the 11-tap filter size.

FIG. 13 shows a an example of a processing system or device 1300 configured to perform various video debanding aspects as described herein. The device 1300 may correspond to, for example, one of the wireless communication devices 115-a and 115-b shown in FIG. 1B. In this regard, the device 1300 may implement the decoding device 112 including the debanding component 1360 or may implement the debanding component 1360 separate from the decoding device 112.

The hardware components and subcomponents of the device 1300 may be configured to implement or perform one or more methods (e.g., methods 1400 and 1500 in FIGS. 14 and 15, respectively) described herein in accordance with various aspects of the present disclosure. In particular, the hardware components and subcomponents of the device 1300 may perform techniques for video debanding to remove or reduce banding artifacts by using adaptive filter sizes and gradient based banding detection.

An example of the device 1300 may include a variety of components such as a memory 1310, one or more processors 1320, and a transceiver 1330, which may be in communication with one another via one or more buses, and which may operate to enable one or more of the video debanding functions and/or operations described herein, including one or more methods of the present disclosure.

The transceiver 1330 may include a receiver 1340 configured to receive information representative of video data (e.g., receive encoded video data from a source device). Additionally or alternatively, the transceiver 1330 may include a transmitter 1350 configured to transmit information representative of video data (e.g., transmit encoded video data to a receiving or destination device). The receiver 1340 may be a radio frequency (RF) device and may be configured to demodulate signals carrying the information representative of the video data in accordance with a cellular or some other wireless communication standard. Similarly, the transmitter 1350 may be an RF device and may be configured to modulate signals carrying the information representative of the video data in accordance with a cellular or some other wireless communication standard.

The various functions and/or operations described herein may be included in, or be performed by, the one or more processors 1320 and, in an aspect, may be executed by a single processor, while in other aspects, different ones of the functions and/or operations may be executed by a combination of two or more different processors. For example, in an aspect, the one or more processors 1320 may include any one or any combination of an image/video processor, a modem processor, a baseband processor, or a digital signal processor.

The one or more processors 1320 may be configured to perform or implement the decoding device 112, including the video debanding component 1360. Alternatively, the one or more processors 1320 may be configured to perform or implement the video debanding component 1360 separate from the decoding device 112. For example, aspects of the video debanding component 1360 may be performed or implemented after the decoding of a video image by the decoding device 112.

The video debanding component 1360 may include a banding artifact detection component 1370 configured to detect or identify banding artifacts. The banding artifact detection component 1370 may perform banding detection as described above on a per pixel basis to determine whether the pixel has a banding artifact or is associated with a banding artifact.

The banding artifact detection component 1370 may include a flat area detection 1372 configured to perform aspects associated with the first step of banding detection described above. For example, the flat area detection 1372 may be configured to perform aspects related to Equation (1) to determine whether the first step of banding detection is met or found to pass (e.g., filter size being considered is good for a flat area or region about the target pixel to be filtered) or fail (e.g., filter size being considered is not good for a flat area or region about the target pixel to be filtered).

The banding artifact detection component 1370 may also include a gradient based detection 1374 configured to perform aspects associated with the second step of banding detection. For example, the gradient based detection 1374 may be configured to determine whether the non-zero gradients in a filter kernel (e.g., filter kernel 1388) have the same sign (e.g., whether they are all positive (+) or negative (−)), and whether the non-zero gradients are smaller than a threshold value. Accordingly, the gradient based detection 1374 may be configured to determine whether the second step of banding detection is met or found to pass (e.g., filter size meets the appropriate non-zero gradient sign and size conditions), or is not met or fails (e.g., filter size does not meet the appropriate non-zero gradient sign and size conditions).

The banding artifact detection component 1370 may therefore determine that a filter size for a debanding filter meets or passes banding detection when both the flat area detection 1372 indicates that the filter size being considered (e.g., the current filter size in scheme or algorithm 1100) is found to pass the first step of banding detection and the gradient based detection 1374 indicates that the filter size being considered is found to pass the second step of banding detection.

The video debanding component 1360 may also include a filter component 1380 configured to perform various aspects described herein for adaptive debanding filtering. The filter component 1380 may include a filter size initialization 1382, a set of filter sizes 1384, a filter size adaptation 1386, and the filter kernel 1388.

The set of filter sizes 1384 may include at least one filter size supported by the filter component 1380 to use for a debanding filter as part of video debanding operations. In an example, the set of filter sizes may include, for video processing that uses 16×16 macroblocks, the following filter sizes: a 3-tap filter size, a 7-tap filter size, an 11-tap filter size, and a 15-tap filter size. Sets of filter sizes with more or fewer sizes may also be used, as well as sets of filter sizes with different filter sizes than those provided in the example.

The filter size initialization 1382 may be configured to select an initial or first filter size from the set of filter sizes 1384 to be used with a debanding filter. For example, the filter size initialization 1382 may select the initial or first filter size as described in the scheme or algorithm 110 in FIG. 11. In one example, the initial filter size may be the smallest of the filter sizes in the set of filter sizes 1384. In another example, the initial filter size may be different from the smallest of the filter sizes in the set of filter sizes 1384 if there is an instruction or indication to use a filter size different from the smallest filter size as the initial or first filter size. For example, feedback from previous debanding filtering may be used to determine that the initial filter size for a particular pixel may be different than the smallest filter size in the set of filter sizes 1384.

The filter size adaptation 1386 may be configured to change or modify the size of a debanding filter 1390 as part of an adaptation scheme like the scheme or algorithm 1100 in FIG. 11. The filter size adaptation 1386 may be configured to determine when a current size of the debanding filter 1390 is to be increased to a larger filter size in the set of filter sizes 1384, and when a current size of the debanding filter 1390 need not be changed because the size is suitable or appropriate for the contents and/or the size of the contents of a video image.

The video debanding component 1360 may also include a cascaded detection/filtering component 1392 configured to control, coordinate, and/or otherwise manage the cascading of video debanding in different directions. In one aspect, the cascaded detection/filtering component 1392 may configure aspects of the video debanding component 1360 to structure functions and/or operations as described in FIGS. 7A and 7B. For example, the cascaded detection/filtering component 1392 may configure the banding artifact detection component 1370 and the filter component 1380 to perform the functions of the vertical banding detection/filtering 712 and the horizontal banding detection/filtering 714 in FIG. 7A. Moreover, the cascaded detection/filtering component 1360 may configure the dither component 1394 to correspond to the dither 716 in FIG. 7A.

Similarly, the cascaded detection/filtering component 1392 may configure the banding artifact detection component 1370 and the filter component 1380 to perform the functions of the horizontal banding detection/filtering 732 and the vertical banding detection/filtering 734 in FIG. 7B. Moreover, the cascaded detection/filtering component 1360 may configure the dither component 1394 to correspond to the dither 736 in FIG. 7B.

The memory 1310 may be configured to store data used herein and/or local versions of applications being executed by at least one processor 1320. The memory 1310 may include any type of computer-readable medium usable by a computer or at least one processor 1320, such as random access memory (RAM), read only memory (ROM), tapes, magnetic discs, optical discs, volatile memory, non-volatile memory, and any combination thereof. In an aspect, for example, the memory 1320 may be a non-transitory computer-readable storage medium that stores one or more computer-executable codes that may be executed by the one or more processors 1320 to implement or perform the various video debanding functions and/or operations described herein.

Referring to FIG. 14, a flow chart illustrating an example method 1400 for video debanding is shown. For clarity and without limitation, the method 1400 may be described below with reference to one or more of the aspects described with reference to FIGS. 1A, 1B, 7A, 7B, 11, and 13. In some examples, the device 1300 may execute one or more of the components described below, which may be implemented and/or defined in the one or more processors 1320, or in one or more sets of codes or instructions stored on a computer-readable medium (e.g., the memory 1310) as software or firmware and executable by a processor 1320, or programmed directly into a hardware element such as a module or subcomponent of a processor 1320, to control one or more components of the device 1300 to perform the functions described below.

At 1410, the method 1400 may optionally include receiving information representative of video data. The information may be received by, for example, the receiver 1340 at the device 1300, and then forwarded to the video debanding component 1360 for further processing. The information received may be modulated according to a cellular communication standard. Moreover, the video data may include one or more video images having banding or contouring artifacts.

At 1412, the method 1400 may include performing banding artifact detection on a target pixel location in the video data. In one example, banding artifact detection, or banding detection, may be performed by any one of the decoding device 112, the vertical banding detection/filtering 712 and 734, the horizontal banding detection/filtering 714 and 732, the video debanding component 1630, and/or the banding artifact detection component 1370. The banding detection may include performing the first step of banding detection (e.g., by flat area detection 1372) and the second step of banding detection (e.g., by gradient based detection 1374).

At 1414, the method 1400 may include adapting, in response to the detection of a banding artifact, a filter size based on content in the video data, the filter size being adapted from a set of filter sizes (e.g., set of filer sizes 1384). In an example, the filter size adaptation may be performed in accordance with the scheme or algorithm 1100 described above in connection with FIG. 11. For example, the size of a debanding filter (e.g., the debanding filter 1390) may be adapted (e.g., increased) as shown in 1160 of FIG. 11. Moreover, the filter size adaptation may be performed by one or more of decoding device 112, the vertical banding detection/filtering 712 and 734, the horizontal banding detection/filtering 714 and 732, the video debanding component 1630, the filter component 1380, and/or the filter size adaptation 1386. In another aspect, a maximum filter size in the set of filter sizes may be based on a macroblock size of the video data.

At 1416, the method 1400 may include applying, to a value of the target pixel location, a debanding filter (e.g., debanding filter 1390) having the adapted filter size to at least reduce the banding artifact. In an example, the application of the adapted filter size may be performed in accordance with the scheme or algorithm 1100 described above in connection with FIG. 11. For example, a debanding filter with adapted filter size may be applied as shown in 1150 of FIG. 11. Moreover, the application of the adapted filter size may be performed by one or more of decoding device 112, the vertical banding detection/filtering 712 and 734, the horizontal banding detection/filtering 714 and 732, the video debanding component 1630, the filter component 1380, the debanding filter 1390, and/or the filter size adaptation 1386. In another aspect, the debanding filter may be a one-dimensional (1D) separable filter configured to be applied horizontally or vertically on the video data.

At 1418, the method 1400 may optionally include outputting the filtered value of the target pixel location. For example, when performing video debanding on a video image in a first direction, the filtered values of the pixels of the video image (e.g., the filtered video image) may be provided for video debanding in a second direction. Then, after performing video debanding in the second direction, the filtered values of the pixels of the filtered video image may be provided for further processing, such as dithering, for example. In this regard, producing or generating filtered values of pixels of a video image may be performed by the decoding device 112, the vertical banding detection/filtering 712 and 734, the horizontal banding detection/filtering 714 and 732, the video debanding component 1630, and/or the filter component 1380.

In another aspect of the method 1400, performing the banding artifact detection may include detecting whether there is a banding artifact for a current filter size, and adapting the filter size may include changing (e.g., increasing) the current filter size to a different filter size from the set of filter sizes.

In another aspect of the method 1400, detecting whether there is a banding artifact for the current filter size includes determining whether the target pixel location is in a flat area of the video data (e.g., determining whether the first step or criterion of banding detection passes or fails), and determining whether non-zero gradients between values of pixel locations associated with a filter kernel (e.g., filter kernel 1388) for the current filter size have the same sign and satisfy a threshold, wherein the pixel locations include the target pixel location (e.g., determining whether the second step or criterion of banding detection passes or fails). In a further aspect, a banding artifact is detected for the current filter size in response to a determination that the target pixel location is in a flat area of the video data, and the non-zero gradients have the same sign and satisfy the threshold. In yet another aspect, a banding artifact is not detected for the current filter size in response to a determination that the target pixel location is not in a flat area of the video data, the non-zero gradients do not have the same sign, or at least one of the non-zero gradients does not satisfy the threshold.

In another aspect of the method 1400, determining whether the target pixel location is in a flat area of the video data includes applying, to the value of the target pixel location, the debanding filter having a current filter size to produce a filtered value of the target pixel location, determining a difference between the filtered value of the target pixel location and the value of the target pixel location, and determining that the target pixel location is in a flat area of the video data when the difference is smaller than a threshold.

In another aspect of the method 1400, the method may further include setting an initial filter size to be a smallest filter size in the set of filter sizes, where performing the banding artifact detection includes detecting whether there is a banding artifact for the initial filter size, and where adapting the filter size includes changing the initial filter size to a next larger filter size in the set of filter sizes in response to a banding artifact being detected for the initial filter size as a part of the banding artifact detection. Examples of these aspects are illustrated in connection with the scheme or algorithm 1100 in FIG. 11 and diagram 1200 in FIG. 12.

In yet another aspect of the method 1400, the method may further include performing banding artifact detection on the target pixel location for at least one filter size in the set of filter sizes larger than the next larger filter size, and adapting the filter size to that of the largest of the at least one filter size for which a banding artifact is detected.

In yet another aspect of the method 1400, the method may be executable on a wireless communication device, where the device (e.g., the device 1300) includes a memory (e.g., the memory 1310) configured to store the video data, a processor (e.g., the one or more processors 1320) configured to execute instructions to process the video data stored in the memory, and a receiver (e.g., the receiver 1340) configured to receive information representative of the video data. The wireless communication device may be a cellular telephone and the information representative of the video data may be received by the receiver and modulated according to a cellular communication standard.

Referring to FIG. 15 a flow chart illustrating an example method 1500 for video debanding is shown. For clarity and without limitation, the method 1500 may be described below with reference to one or more of the aspects described with reference to FIGS. 1A, 1B, 7A, 7B, 11, and 13. In some examples, the device 1300 may execute one or more of the components described below, which may be implemented and/or defined in the one or more processors 1320, or in one or more sets of codes or instructions stored on a computer-readable medium (e.g., the memory 1310) as software or firmware and executable by a processor 1320, or programmed directly into a hardware element such as a module or subcomponent of a processor 1320, to control one or more components of the device 1300 to perform the functions described below.

At 1510, the method 1500 may optionally include receiving information representative of video data. The information may be received by, for example, the receiver 1340 at the device 1300, and then forwarded to the video debanding component 1360 for further processing. The information received may be modulated according to a cellular communication standard. Moreover, the video data may include one or more video images having banding or contouring artifact.

At 1512, the method 1500 may include performing a first banding artifact correction in a first direction on a target pixel location in the video data based on a first debanding filter. For example, the vertical banding detection/filtering 712 in FIG. 7A may perform a first banding artifact correction (e.g., video debanding) in the vertical direction. In another example, the horizontal banding detection/filtering 732 in FIG. 7B may perform a first banding artifact correction (e.g., video debanding) in the horizontal direction.

The first banding artifact correction may include performing banding artifact detection on the target pixel location, adapting, in response to the detection of a banding artifact, a filter size of the first debanding filter based on content in the video data, the filter size being adapted from a set of filter sizes, and applying, to a value of the target pixel location, the first debanding filter having the adapted filter size to produce a filtered value of the target pixel location. These aspects may be performed by one or more of the decoding device 112, the vertical banding detection/filtering 712, the horizontal banding detection/filtering 732, the video debanding component 1630, the banding artifact detection component 1370, the filter component 1380, the debanding filter 1390, and/or the filter size adaptation 1386.

At 1514, the method 1500 may include performing a second banding artifact correction in a second direction on the target pixel location in the video data based on a second debanding filter. For example, the horizontal banding detection/filtering 714 in FIG. 7A may perform a second banding artifact correction (e.g., video debanding) in the horizontal direction. In another example, the vertical banding detection/filtering 734 in FIG. 7B may perform a second banding artifact correction (e.g., video debanding) in the vertical direction.

The second banding artifact correction may include performing banding artifact detection on the target pixel, adapting, in response to the detection of a banding artifact, a filter size of the second debanding filter based on content in the video data, the filter size being adapted from the set of filter sizes, and applying, to the filtered value of the target pixel location, the second debanding filter having the adapted filter size. These aspects may be performed by one or more of the decoding device 112, the horizontal banding detection/filtering 714, the vertical banding detection/filtering 734, the video debanding component 1630, the banding artifact detection component 1370, the filter component 1380, the debanding filter 1390, and/or the filter size adaptation 1386.

At 1516, the method 1500 may optionally include outputting the corrected value of the target pixel location. For example, the output cascading the first banding artifact correction and the second banding artifact correction may be provided to a dithering operation (e.g., dither 716, dither 736, dither component 1394) to produce a video image that has been corrected for banding artifacts.

In another aspects of the method 1500, the first direction may be a horizontal direction of the video data and the second direction may be a vertical direction of the video data. In yet another aspect, the first direction may be the vertical direction of the video data and the second direction may be the horizontal direction of the video data. The cascaded detection/filtering component 1392 may be configured to determine or assign the first direction and the second direction. In yet another aspect, the cascaded detection/filtering component 1392 may determine whether to configure the video debanding component 1360 to use a horizontal direction or a vertical direction as the first direction, and to use the other direction as the second direction.

In yet another aspect of the method 1500, each of the first debanding filter and the second debanding filter is a one-dimensional (1D) separable filter.

In another aspect of the method 1500, the method may be executable on a wireless communication device, where the device (e.g., the device 1300) includes a memory (e.g., the memory 1310) configured to store the video data, a processor (e.g., the one or more processors 1320) configured to execute instructions to process the video data stored in the memory, and a receiver (e.g., the receiver 1340) configured to receive information representative of the video data. The wireless communication device may be a cellular telephone and the information representative of the video data may be received by the receiver and modulated according to a cellular communication standard.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The disclosure set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The disclosure includes specific details for the purpose of providing an understanding of the described techniques. These techniques, however, may be practiced without these specific details. In some instances, well-known structures and apparatuses are shown in block diagram form in order to avoid obscuring the concepts of the described examples.

The functions described herein may be implemented in hardware, software executed by a processor, firmware, or any combination thereof. If implemented in software executed by a processor, the functions may be stored on or transmitted over as one or more instructions or code on a (non-transitory) computer-readable medium. Other examples and implementations are within the scope and spirit of the disclosure and appended claims. For example, due to the nature of software, functions described above can be implemented using software executed by a specially programmed processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable medium as described herein may include transient media, such as a wireless broadcast or wired network transmission, or storage media (that is, non-transitory storage media), such as a hard disk, flash drive, compact disc, digital video disc, Blu-ray disc, or other computer-readable media. In some examples, a network server (not shown) may receive encoded video data from the source device and provide the encoded video data to the destination device, e.g., via network transmission. Similarly, a computing device of a medium production facility, such as a disc stamping facility, may receive encoded video data from the source device and produce a disc containing the encoded video data. Therefore, the computer-readable medium may be understood to include one or more computer-readable media of various forms, in various examples.

What is claimed is:

1. A method for processing banding artifacts in video data, the method comprising:
performing banding artifact detection on a target pixel location in the video data;
adapting, in response to the detection of a banding artifact, a filter size based on content in the video data, the filter size being adapted from a set of filter sizes; and
applying, to a value of the target pixel location, a debanding filter having the adapted filter size to at least reduce the banding artifact.

2. The method of claim 1, wherein:
performing the banding artifact detection comprises detecting whether there is a banding artifact for a current filter size, and
adapting the filter size comprises changing the current filter size to a different filter size from the set of filter sizes.

3. The method of claim 2, wherein detecting whether there is a banding artifact for the current filter size comprises:
determining whether the target pixel location is in a flat area of the video data; and
determining whether non-zero gradients between values of pixel locations associated with a filter kernel for the current filter size have the same sign and satisfy a threshold, wherein the pixel locations include the target pixel location.

4. The method of claim 3, wherein a banding artifact is detected for the current filter size in response to a determination that:
the target pixel location is in a flat area of the video data, and
the non-zero gradients have the same sign and satisfy the threshold.

5. The method of claim 3, wherein a banding artifact is not detected for the current filter size in response to a determination that:
the target pixel location is not in a flat area of the video data,
the non-zero gradients do not have the same sign, or
at least one of the non-zero gradients does not satisfy the threshold.

6. The method of claim 3, wherein determining whether the target pixel location is in a flat area of the video data comprises:
applying, to the value of the target pixel location, the debanding filter having a current filter size to produce a filtered value of the target pixel location;
determining a difference between the filtered value of the target pixel location and the value of the target pixel location; and
determining that the target pixel location is in a flat area of the video data when the difference is smaller than a threshold.

7. The method of claim 1, further comprising:
setting an initial filter size to be a smallest filter size in the set of filter sizes,
wherein performing the banding artifact detection comprises detecting whether there is a banding artifact for the initial filter size, and
wherein adapting the filter size comprises changing the initial filter size to a next larger filter size in the set of filter sizes in response to a banding artifact being detected for the initial filter size as a part of the banding artifact detection.

8. The method of claim 7, further comprising:
performing banding artifact detection on the target pixel location for at least one filter size in the set of filter sizes larger than the next larger filter size; and
adapting the filter size to that of the largest of the at least one filter size for which a banding artifact is detected.

9. The method of claim 1, wherein a maximum filter size in the set of filter sizes is based on a macroblock size of the video data.

10. The method of claim 1, wherein the debanding filter is a one-dimensional (1D) separable filter configured to be applied horizontally or vertically on the video data.

11. The method of claim 1, the method being executable on a wireless communication device, wherein the device comprises:
a memory configured to store the video data;
a processor configured to execute instructions to process the video data stored in the memory; and
a receiver configured to receive information representative of the video data.

12. The method of claim 11, wherein the wireless communication device is a cellular telephone and the information representative of the video data is received by the receiver and modulated according to a cellular communication standard.

13. A device for processing banding artifacts in video data, the device comprising:
a memory configured to store the video data; and
a processor configured to:
perform banding artifact detection on a target pixel location in the video data;
adapt, in response to the detection of a banding artifact, a filter size based on content in the video data, the filter size being adapted from a set of filter sizes; and
apply, to a value of the target pixel location, a debanding filter having the adapted filter size to at least reduce the banding artifact.

14. The device of claim 13, wherein:
the processor configured to perform the banding artifact detection is further configured to detect whether there is a banding artifact for a current filter size, and
the processor configured to adapt the filter size is further configured to change the current filter size to a different filter size from the set of filter sizes.

15. The device of claim 14, wherein the processor configured to detect whether there is a banding artifact for the current filter size is further configured to:
determine whether the target pixel location is in a flat area of the video data; and
determine whether non-zero gradients between values of pixel locations associated with a filter kernel for the current filter size have the same sign and satisfy a threshold, wherein the pixel locations include the target pixel location.

16. The device of claim 15, wherein a banding artifact is detected for the current filter size in response to a determination by the processor that:
the target pixel location is in a flat area of the video data, and
the non-zero gradients have the same sign and satisfy the threshold.

17. The device of claim 15, wherein a banding artifact is not detected for the current filter size in response to a determination by the processor that:
the target pixel location is not in a flat area of the video data,
the non-zero gradients do not have the same sign, or
at least one of the non-zero gradients does not satisfy the threshold.

18. The device of claim 15, wherein the processor configured to determine whether the target pixel location is in a flat area of the video data is further configured to:
apply, to the value of the target pixel location, the debanding filter having a current filter size to produce a filtered value of the target pixel location;
determine a difference between the filtered value of the target pixel location and the value of the target pixel location; and
determine that the target pixel location is in a flat area of the video data when the difference is smaller than a threshold.

19. The device of claim 13, wherein the processor is further configured to:
set an initial filter size to be a smallest filter size in the set of filter sizes;
detect whether there is a banding artifact for the initial filter size; and
change the initial filter size to a next larger filter size in the set of filter sizes in response to a banding artifact being detected for the initial filter size.

20. The device of claim 19, wherein the processor is further configured to:
perform banding artifact detection on the target pixel location for at least one filter size in the set of filter sizes larger than the next larger filter size; and
adapt the filter size to that of the largest of the at least one filter size for which a banding artifact is detected.

21. The device of claim 13, wherein a maximum filter size in the set of filter sizes is based on a block size of the video data.

22. The device of claim 13, wherein the debanding filter is a one-dimensional (1D) separable filter configured to be applied horizontally or vertically on the video data.

23. The device of claim 13, wherein the device is a wireless communication device, further comprising:
a receiver configured to receive information representative of the video data.

24. The device of claim 23, wherein the wireless communication device is a cellular telephone and the information is received by the receiver and modulated according to a cellular communication standard.

25. A computer-readable medium storing code for processing banding artifacts in video data, the code being executable by a processor to perform a method comprising:
performing banding artifact detection on a target pixel location in the video data;
adapting, in response to the detection of a banding artifact, a filter size based on content in the video data, the filter size being adapted from a set of filter sizes; and
applying, to a value of the target pixel location, a debanding filter having the adapted filter size to at least reduce the banding artifact.

26. A method for processing banding artifacts in video data, the method comprising:
performing a first banding artifact correction in a first direction on a target pixel location in the video data based on a first debanding filter, the first banding artifact correction including:
performing banding artifact detection on the target pixel location;
adapting, in response to the detection of a banding artifact, a filter size of the first debanding filter based on content in the video data, the filter size being adapted from a set of filter sizes; and
applying, to a value of the target pixel location, the first debanding filter having the adapted filter size to produce a filtered value of the target pixel location; and
performing a second banding artifact correction in a second direction on the target pixel location based on a second debanding filter, the second banding artifact correction including:
performing banding artifact detection on the target pixel location;
adapting, in response to the detection of a banding artifact, a filter size of the second debanding filter based on content in the video data, the filter size being adapted from the set of filter sizes; and
applying, to the filtered value of the target pixel location, the second debanding filter having the adapted filter size.

27. The method of claim 26, wherein:
the first direction is a horizontal direction of the video data and the second direction is a vertical direction of the video data, or
the first direction is the vertical direction of the video data and the second direction is the horizontal direction of the video data.

28. The method of claim 26, wherein each of the first debanding filter and the second debanding filter is a one-dimensional (1D) separable filter.

29. The method of claim 26, the method being executable on a wireless communication device, wherein the device comprises:
a memory configured to store the video data;
a processor configured to execute instructions to process the video data stored in the memory; and
a receiver configured to receive information representative of the video data.

30. The method of claim 29, wherein the wireless communication device is a cellular telephone and the information representative of the video data is received by the receiver and modulated according to a cellular communication standard.
